(19) United States
(12) Patent Application Publication
(10) Pub. No.: US 2012/0324199 A1
(43) Pub. Date: Dec. 20, 2012

(54) MEMORY MANAGEMENT METHOD, COMPUTER SYSTEM AND PROGRAM

(75) Inventors: Ryozo Yamashita, Yokohama (JP); Hiroyasu Nishiyama, Kawasaki (JP); Tomoya Ohta, Sagamihara (JP)

(73) Assignee: HITACHI, LTD., Tokyo (JP)

(21) Appl. No.: 13/391,566

(22) PCT Filed: Mar. 4, 2010
(86) PCT No.: PCT/JP2010/054060

§ 371 Date: Jul. 16, 2012

(30) Foreign Application Priority Data
Nov. 12, 2009 (JP) 2009-258816

(51) Int. Cl. G06F 12/00

(52) U.S. Cl. 711/170; 711/E12.084

(57) ABSTRACT

Disclosed is a computer system for reliably running a plurality of programs performing garbage collection with less physical memory than in the past. For this purpose, there is disclosed a memory management method that releases unneeded areas in a plurality of memory areas that have been used by each of a plurality of programs stored in memory and executed on a processing unit, the processing unit acquires an index for determining the start of releasing a memory area, compares the index with a predetermined threshold, and when the index exceeds the threshold, selects one of the plurality of programs, collects unneeded areas of the memory areas used by the selected program, and releases the collected areas.

### BACKGROUND OF THE INVENTION

This invention relates to a memory management method, a computer system, and a program, and more particularly, to garbage collection processing of objects.

Garbage collection (hereinafter, referred to as GC) is known as implicit collection means for objects allocated on a memory used by a program in a computer system (see, for example, Garbage Collection: Algorithms for Automatic Dynamic Memory Management (Richard Jones, Rafael Lins, 1996, John Wiley & Sons Inc, ISBN:978-0471941484), p183). The GC determines presence/absence of possibility that each of objects on the memory is to be used by a program, and collects objects with no possibility (hereinafter, referred to as “garbage objects”) to release regions on the memory. The GC is used by the Java™ virtual machine (hereinafter, referred to as “Java VM”) and the like. (Java, and all Java-based trademarks and logos are trademarks or registered trademarks of Sun Microsystems, Inc. in the U.S. and other countries.)

Generally, a program using the GC for memory management simply continues allocation of a new object without the GC processing while there is a free area in the memory area, and carries out the GC processing when a free area becomes no longer available. As a result, a memory usage ratio of the program using the GC has a characteristic that the ratio is minimum after the GC execution, increases as the time elapses, and reaches a peak immediately before a next GC execution. Due to this characteristic, when a plurality of programs using the GC simultaneously run, there is a tendency that a memory capacity needed simultaneously is maximum if the timings of executing the GC processing for all the program are the same, and conversely decreases as the GC execution timings differ more greatly from one another among the programs.

Moreover, a configuration in which a software program called hypervisor is used to control a plurality of virtual computer systems (virtual machines) to operate on one computer system has recently become popular. The hypervisor provides a function of releasing a physical memory which has become no longer necessary for a program operating on the virtual machine. The hypervisor can allocate the released physical memory to other virtual machines as necessary, thereby increasing memory utilization efficiency as the entire system (see, for example, Carl A. Waldspurger, Memory resource management in VMware ESX server, ACM SIGOPS Operating Systems Review Volume 36, Issue SI (Winter 2002), pp. 181-194). Moreover, the operating system, which has conventionally been widely used, also has a function of operating a plurality of programs on one computer system, and provides a function of releasing a physical memory which is no longer necessary in the same manner as the hypervisor does (see, for example, Understanding the Linux Kernel, Third Edition (Daniel P. Bovet, Marco Cesati, 2007, O'Reilly Japan, Inc., ISBN: 978-4873113135), p377).

Although this invention is intended to be applied to the memory, it is known that a usage ratio of a storage device such as a disk by a log-structured file system (see, for example, Rosenblum, Mendel and Ousterhout, John K., The LFS Storage Manager, Proceedings of the 1990 Summer Usenix, pp. 315-324) and an append-only database (see, for example, Philip A. Bernstein, Nathan Goodman, Concurrency Control in Distributed Database Systems, ACM Computing Surveys (CSUR) Volume 13, Issue 2 (June 1981), pp. 185-221) presents the same usage ratio characteristic as that of the memory which is described above.

### SUMMARY OF THE INVENTION

In the above-mentioned conventional example, if a plurality of programs run at the same time, a physical memory equal to a sum of the capacities of the memory areas used by all the programs is generally reserved in advance. However, due to the above-mentioned characteristic of the GC, if the plurality of the programs use the GC, and the GC execution timings are always different from one another among the programs, the sum of the used capacities of the physical memory can be reduced without degradation in performance by giving/receiving unnecessary physical memories among the programs. This means that the physical memory capacity necessary for reservation in advance for executing the programs can be reduced compared with the conventional case.

However, if there is no difference in the GC execution timing among the programs, the same capacity of physical memory as in the conventional case is necessary regardless of unnecessary physical memories being given/received. The GG execution timings of the plurality of the programs cannot be controlled by the conventional technology, and if the capacity of the provided physical memory is reduced under the assumption that there is a difference in the GC execution timing, and if the GC timings overlap, then the memory may fall short, which results in an extreme degradation in performance.

Moreover, when the GC timings overlap, in addition to the above-mentioned problem, a plurality of programs stop calculation processing due to the carrying out of the GC processing, and there also occurs a problem of degradation in responsiveness.

This invention has been made in view of above-mentioned problems, and therefore has an object to provide a computer system stably operating on a physical memory smaller in capacity than in the conventional case by controlling timings of the GC execution among a plurality of programs which use the GC.

This invention carries out garbage collection in one of a plurality of programs when a certain index regarding a used memory capacity summed over the plurality of programs exceeds a predetermined threshold, and releases a physical memory which has become no longer necessary after the garbage collection.

According to this invention, the programs can thus be stably operated on a memory smaller in capacity than in the conventional case by controlling the GC execution timings of the plurality of programs which use the garbage collection. Moreover, the simultaneous stop of the calculation processing of the plurality of programs is eliminated by controlling the GC execution timings, thereby securing stable responsiveness.

### BRIEF DESCRIPTION OF THE DRAWINGS

FIG. 1 is a configuration block diagram of a computer according to a first embodiment.

FIG. 2 is a diagram illustrating an overview of the GC processing control according to the first embodiment.

FIG. 3 is a diagram illustrating an example of a data format of the control information management table according to the first embodiment.

FIG. 4 is a diagram illustrating an example of a data format of the memory capacity management table according to the first embodiment.

FIG. 5 is a flowchart illustrating an example of heap capacity inquiry processing according to the first embodiment.

FIG. 6 is a flowchart illustrating an example of GC execution opportunity determination processing according to the first embodiment.

FIG. 7 is a flowchart illustrating an example of GC-execution-JavaVM selection processing according to the first embodiment.

FIG. 8 is a flowchart illustrating an example of collection processing according to the first embodiment.

FIG. 9A illustrates a relationship between the used heap capacities and the heap capacities holds according to the prior art.

FIG. 9B illustrates a relationship between the used heap capacities and the heap capacities holds according to the prior art.

FIG. 10A illustrates a relationship between the used heap capacities and the heap capacities holds according to the first embodiment.

FIG. 10B illustrates a relationship between the used heap capacities and the heap capacities holds according to the first embodiment.

FIG. 11 is a diagram illustrating data to be stored in the control information management table 144 according to a second embodiment.

FIG. 12 is a flowchart illustrating an example of selecting the JavaVM to execute the GC according to the second embodiment.

FIG. 13 is a block diagram illustrating a configuration of a computer system centered around a computer according to a third embodiment.

FIG. 14 is a diagram illustrating an overview of the GC processing control according to the third embodiment.

FIG. 15 is a table illustrating data to be stored in the control information management table according to the third embodiment.

FIG. 16 is a table illustrating an example of a data format of the number-of-processed-requests management table according to the third embodiment.

FIG. 17 is a table illustrating an example of a data format of the distribution information management table according to the third embodiment.

FIG. 18 is a configuration block diagram of a computer according to a fourth embodiment.

FIG. 19 is a flowchart illustrating an example of collection processing according to the fourth embodiment.

FIG. 20 is a block diagram illustrating a configuration of a computer according to a fifth embodiment.

FIG. 21 is a diagram illustrating an overview of the GC processing according to the fifth embodiment.

FIG. 22 is a block diagram illustrating a configuration of the computer system according to a sixth embodiment.

FIG. 23 illustrates an overview of the calculation method for the threshold.

FIG. 24 is a diagram illustrating an overview of the GC control processing according to the sixth embodiment.

FIG. 25 is a diagram illustrating data to be stored in the control information management table according to the sixth embodiment.

FIG. 26 is a diagram illustrating data to be stored in the memory capacity management table according to the sixth embodiment.

FIG. 27 is a diagram illustrating an overview of the GC processing according to the sixth embodiment.

FIG. 28 is a flowchart illustrating an example of selecting the JavaVM to execute the GC according to a seventh embodiment.

### DETAILED DESCRIPTION OF THE PREFERRED EMBODIMENTS

A detailed description is now given of embodiments of this invention referring to the drawings. An example in which a JavaVM is used as a program which uses the garbage collection is described in the following embodiments.

### First Embodiment

First, a description is given of an embodiment in which a management program external to JavaVMs carries out an opportunity determination for the GC execution, a sum of used memory capacities in heap areas respectively used by a plurality of programs is used as an index for the opportunity determination, and a JavaVM having the earliest next GC execution opportunity is selected as a subject to which a GC execution instruction is notified when the opportunity of GC execution is reached.

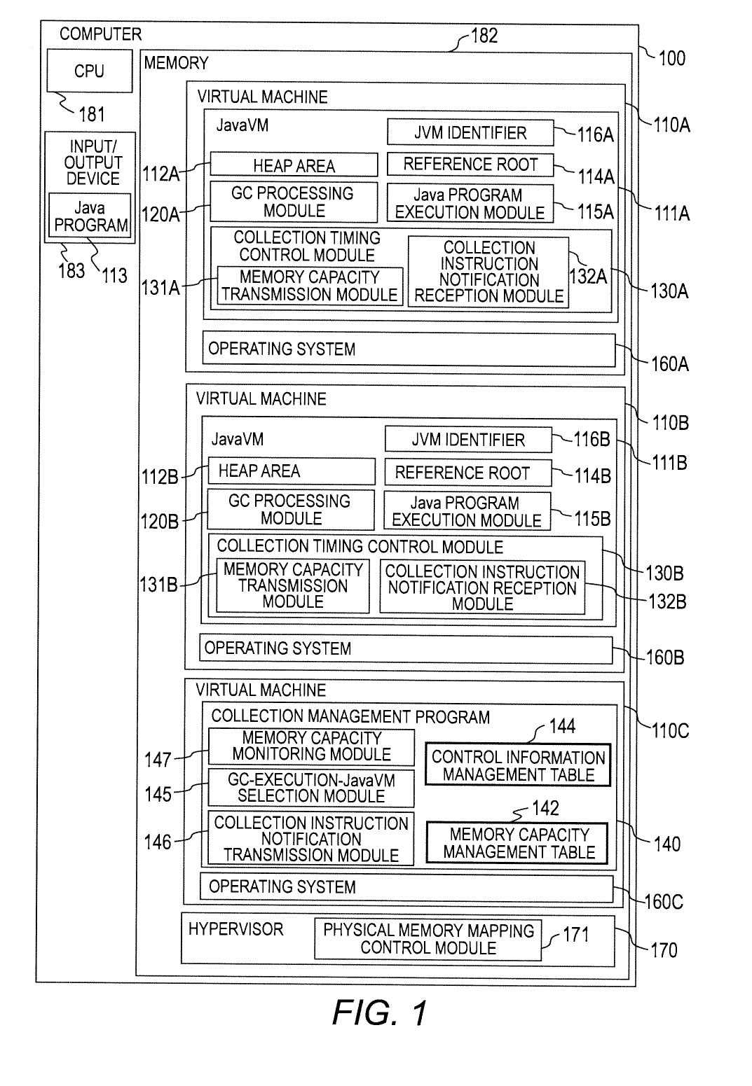

FIG. 1 is a configuration block diagram of a computer according to this embodiment. As illustrated in FIG. 1, the computer 100 according to this embodiment includes a CPU 181, a memory 182, and an input/output device 183. It should be noted that the input/output device 183 includes a disk device, a mouse, a keyboard, and a display, and illustrated Java programs 113 are stored in the disk device serving as a storage medium.

A hypervisor 170 is stored in the memory 182. The hypervisor 170 is executed by the CPU 181, thereby comprising a plurality of virtual machines 110 (110A, 110B, 110C, and so on) on the memory 182. The hypervisor 170 controls allocation of the CPU 181, the memory 182, and the input/output device 183 to the virtual machines 110. The allocation is set by an administrator or the like in advance. The virtual machine 110 emulates a physical computer system by using the allocated CPU 181, the memory 182 and the input/output device 183. The virtualization function for virtualizing the physical computer resources to thereby generate the virtual machines may be realized by generating the virtual machine 110 on a host OS in place of the hypervisor 170.

The hypervisor 170 includes a physical memory mapping control module 171. The physical memory mapping control module 171 is a processing module for controlling capacities of the memory 182 available for programs (JavaVMs 111 (111A, 111B, and so on)) running on the virtual machines 110 managed by the hypervisor 170. The program on the virtual machine 110 can request the physical memory mapping control module 171 to allocate a new memory to the virtual machine 100 on which the program itself is running, and to release an already allocated memory.

Operating systems 160 (160A, 160B, and so on) and JavaVMs 111 run on the virtual machines 110A and 110B. The JavaVM 111 is constituted by a JavaVM identifier 116 (116A, 116B, and so on), a heap area 112 (112A, 112B, and so on), a reference root 114 (114A, 114B, and so on), a Java program execution module 115 (115A, 115B, and so on), a GC processing module 120 (120A, 120B, and so on), and a collection timing control module 130 (130A, 130B, and so on).

The JavaVM identifier 116 holds a unique value among the respective JavaVMs 111 in the computer 100 as an identifier. The value of the JavaVM identifier 116 is set by the administrator or the like in advance. The Java program 113 read from the input/output device 183 to the memory 182 is executed on the JavaVM 111 by the Java program execution module 115. It should be noted that the JavaVMs 111A and 111B respectively execute different Java programs.

The Java program execution module 115 allocates objects which become necessary during the execution of processing of the Java program 113 in the heap area 112. Moreover, the Java program execution module 115 stores a reference to the object in the heap area 112 in the reference root 114, thereby operating the object. When a free area of the heap area 112 is no longer available, the JavaVM 111 calls the GC processing module 120, and the GC processing module 120 collects garbage objects (unnecessary objects) in the heap area 112.

The GC processing by the GC processing module 120 traverses reference relationships of objects in the heap area 112 by starting from the reference root 114, and determines as a garbage object an object which does not reach the last reference destination and then collects the determined objects. This collection is processing for releasing the heap area 112 occupied by the garbage objects to thereby enable storage of new objects. The collection timing control module 130 is constituted by a memory capacity transmission module 131 and a collection instruction notification reception module 132.

The memory capacity transmission module 131 is a processing module for transmitting a currently used capacity of the heap area 112. The collection instruction notification reception module 132 is a processing module for receiving the GC execution instruction, thereby carrying out the collection processing for the heap area 112.

The number of the virtual machines (110A and 110B) on which the JavaVM 111 is running is not necessarily two as illustrated, and a large number of virtual machines may exist and run the JavaVMs 111.

The operating system 160C and the collection management program 140 operate on the virtual machine 110C. The collection management program 140 is a program for controlling the GC execution timing of each of the JavaVMs 111, and is constituted by a control information management table 144, a memory capacity management table 142, a memory capacity monitoring module 147, a GC-execution-JavaVM selection module 145, and a collection instruction notification transmission module 146. The collection management program 140 uses the memory capacity monitoring module 147 to inquire a memory capacity of each of the JavaVMs 111. If the sum of used capacities of memory exceeds the threshold, the collection management program 140 uses the GC-execution-JavaVM selection module 145 to select a JavaVM 111 for executing the GC, and uses the collection instruction notification transmission module 146 to notify the selected JavaVM 111 of the GC execution instruction. The control information management table 144 is a table for storing the threshold. The memory capacity management table 142 is a table for storing the result of the inquiry.

The collection management program 140 does not necessarily run on the same physical machine on which the JavaVMs 111 run, and may run on a different physical machine.

The JavaVMs 111 and the collection management program 140 are stored in the disk device (input/output device 183) serving as a storage medium, and are loaded on the memory 182, and executed by the CPU 181.

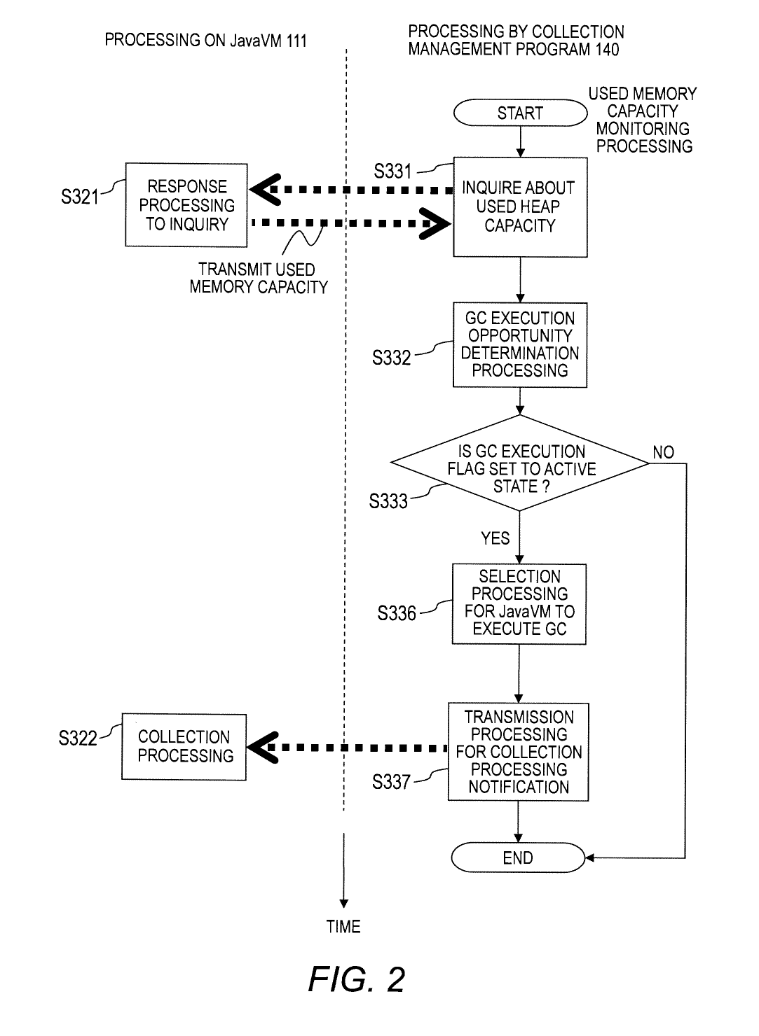

FIG. 2 is a diagram illustrating an overview of the GC processing control according to the first embodiment. The collection management program 140 carries out the processing of FIG. 2 periodically (at a cycle set in advance, for example).

First, the collection management program 140 uses the memory capacity monitoring module 147 to make an inquiry to the memory capacity transmission module 131 periodically (at a cycle set in advance, for example) (S331). The memory capacity transmission module 131 responds to the inquiry with a used heap capacity, which is a currently used capacity of the heap area 112, a heap capacity, and the identifier of the JavaVM 111 (S321).

The result of the response from the memory capacity transmission module 131 is stored in the memory capacity management table 142 by the memory capacity monitoring module 147. If the memory capacity monitoring module 147 determines that the GC execution is necessary based on the inquiry result, the memory capacity monitoring module 147 sets a GC execution flag which is managed by the collection management program 140 to an active state (S332). The collection management program 140 manages one GC execution flag for the computer 100.

The collection management program 140 determines whether the GC execution flag is set to the active state or the inactive state (S333). If it is determined that the GC execution flag is in the active state, the collection management program 140—uses the GC-execution-JavaVM selection module 145 to select one of the JavaVMs 111 (S336).

Next, the collection management program 140 transmits the GC execution instruction to the collection instruction notification reception module 132 of the selected JavaVM by using the collection instruction notification transmission module 146 (S337). In the selected JavaVM, the collection instruction notification reception module 132, which has received the instruction, carries out the collection processing for the heap area 112, thereby releasing the physical memory (S322).

The collection management program 140 does not necessarily make the inquiry to all the JavaVMs 111 Step S331, and, alternatively, all the JavaVMs 111 may report the used heap capacity and the identifier (JVM identifier 221) of the JavaVM 111 to the collection management program 140 periodically (at a predetermined cycle).

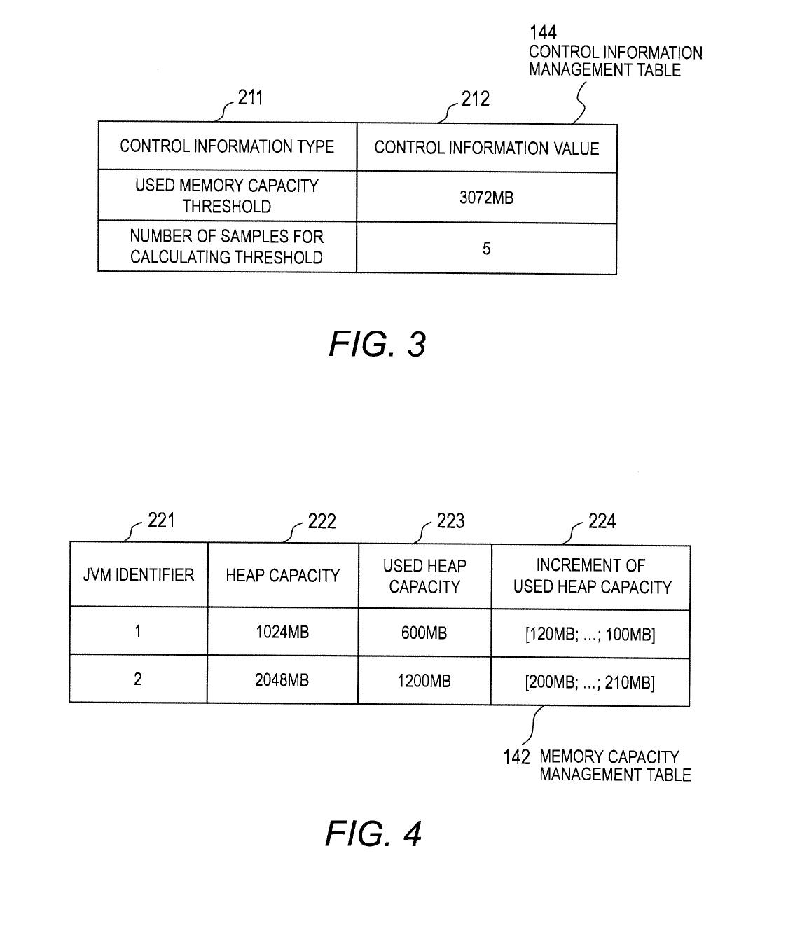

FIG. 3 is a diagram illustrating an example of a data format of the control information management table 144 according to the first embodiment. The control information management table 144 is set by the collection management program 140 of the virtual machine 110C to the memory 182, and constituted by a field of control information type 211 and a field of control information value 212. The field of control information type 211 stores a type of control information to be set. The field of control information value 212 stores a control information value thereof. According to the first embodiment, data stored in the control information management table 144 are a used memory capacity threshold and the number of samples for calculating the threshold. The information on the used memory capacity threshold represents a threshold for the total used heap capacity for all the JavaVMs 111 in the one computer 100. The information on the number of samples for calculating the threshold is the maximum number (N) of pieces of past information on an increment of the used heap capacity used for GC opportunity determination. The values in the control information management table 144 are set by the administrator or the like in advance.

FIG. 4 is a diagram illustrating an example of a data format of the memory capacity management table 142 according to the first embodiment. The memory capacity management table 142 is constituted by a field of JavaVM identifier 221, a field of heap capacity 222, a field of used heap capacity 223, and a field of increment of used heap capacity 224.

The field of JavaVM identifier 221 stores the JavaVM identifier 116 of the JavaVM 111 corresponding to each of data rows in the memory capacity management table 142. The field of heap capacity 222 stores a capacity of the heap area 112 in the corresponding JavaVM 111. The capacity of the heap area 112 is a value of a memory area allocated on the memory 182 by the JavaVM 111.

The field of used heap capacity 223 stores a used capacity of the heap area 112 (used heap capacity) in the corresponding JavaVM 111. In other words, the used heap capacity is the used capacity of the heap area 112 which is a memory area occupied by objects which are written in the heap area 112 by the Java program execution module 115 by using the Java program 113. The used heap capacity is a value indicating an area actually storing the objects out of the heap area 112 allocated on the memory 182 by the JavaVM 111.

The field of increment of used heap capacity 224 stores increments of the used capacity of the heap area 112 in the corresponding JavaVM 111 for the used heap capacity inquiries which have been made at most N times. The increment is obtained by calculating a difference between a new value in the used heap capacity field 223 after the used heap capacity inquiry processing and an old value in the used heap capacity 223 on the start of the used heap capacity inquiry processing. It should be noted that N is a value stored in the number of samples for calculating the threshold in the control information management table 144.

Each row is produced, and the field of JavaVM identifier 221 and the field of heap capacity 222 are set in the memory capacity management table 142 in advance by the administrator or the like. Moreover, the field of used heap capacity 223 in each row is initialized to zero in advance. The field of increment of used heap capacity 224 is initialized to a null list by the management program 140 when the management program 140 is activated.

A description is now given of S331, S332, S336, and S321, which are particularly characteristic pieces of processing of the first embodiment in the processing of FIG. 2, referring to the flowcharts.

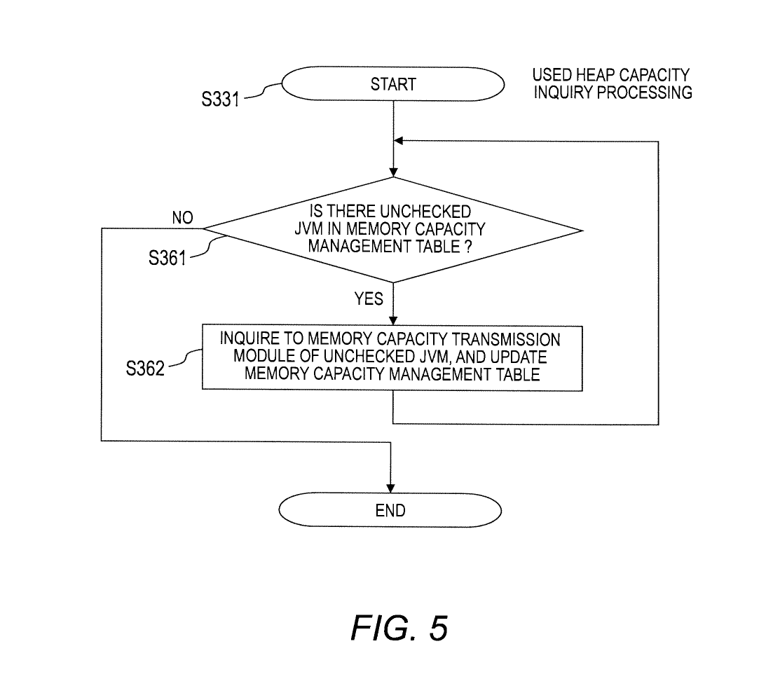

A detailed description is first given of the used heap capacity inquiry processing S331 by the memory capacity monitoring module 147 of the collection management program 140 of the virtual machine 110C, referring to the flowchart in FIG. 5.

In FIG. 5, the memory capacity monitoring module 147 inquires, of the memory capacity transmission modules 131 of all of the JavaVMs 111 registered to the memory capacity management table 142, currently used heap capacities. The memory capacity transmission module 131 of each of the JavaVMs 111 responds with the used heap capacity and the identifier of the JavaVM 111 to the virtual machine 110C executing the collection management program 140 in response to the inquiry from the memory capacity monitoring module 147 of the collection management program 140.

The memory capacity monitoring module 147 of the collection management program 140 receives the result of the inquiry from the memory capacity transmission module 131, and then updates the field of used heap capacity 223 corresponding to the identifier of the JavaVM 111 of the destination of the inquiry in the memory capacity management table 142 with the result of the inquiry. Moreover, the memory capacity monitoring module 147 adds an increment of the used heap capacity 223 to the corresponding field of increment of used heap capacity 224 in the memory capacity management table 142. The field of increment of used heap capacity 223 is acquired by subtracting the used heap capacity field 223 before the update from the used heap capacity field 223 after the update. Moreover, if the number of the elements in the list of the increment of used heap capacity field 224 exceeds the number of samples for calculating the threshold as a result of the addition of the data, the data may be deleted from the list from the chronologically oldest element until the number of the elements is the same as the number of samples for calculating the threshold (S361 and S362).

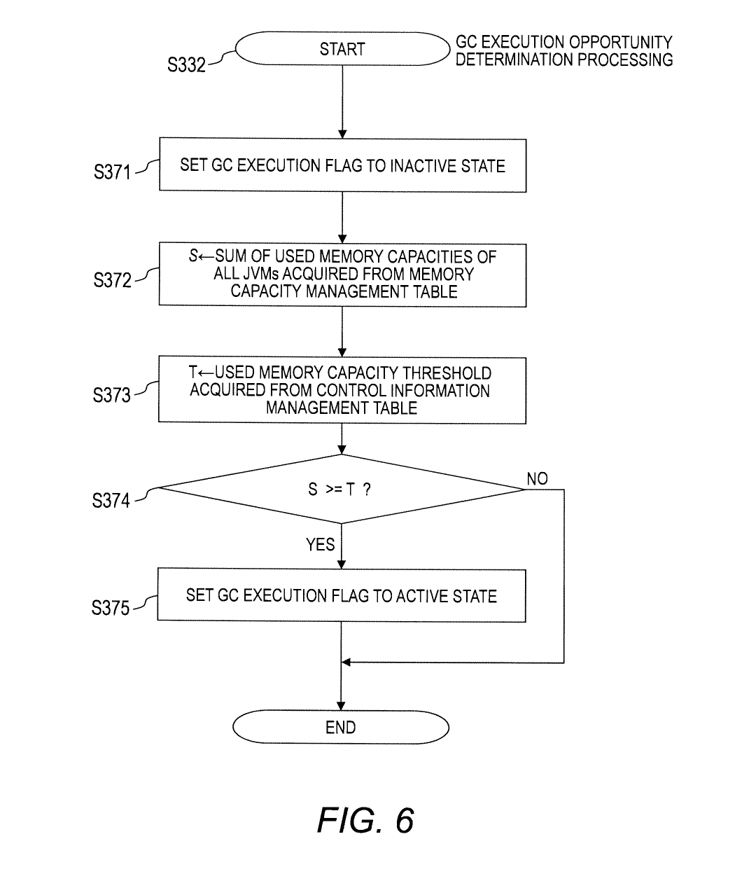

A detailed description is now given of the GC execution opportunity determination processing in S322 by the collection management program 140, referring to FIG. 6.

In FIG. 6, the collection management program 140 acquires a sum of all the used heap capacities 223 in the memory capacity management table 142 and determines whether or not the sum (sum of the used heap capacities) is equal to or larger than the used memory capacity threshold in the control information management table 144. If the sum of the used heap capacities is equal to or larger than the threshold (used memory capacity threshold), the collection management program 140 sets the GC execution flag to the active state (such as 1), and, conversely, if the sum of the used heap capacities is less than the threshold (used memory capacity threshold), the collection management program 140 sets the GC execution flag to the inactive state (such as 0).

First, the collection management program 140 sets the GC execution flag to the inactive state (S371).

Then, the collection management program 140 compares the current sum of the used heap capacities with the threshold (used memory capacity threshold). In more detail, the collection management program 140 acquires the sum of used heap capacities by calculating the sum of the used heap capacity fields 223 corresponding to all the JavaVMs 111 in the memory management table 142 (S372), then acquires the threshold (used memory capacity threshold) from the control information management table 144 (S373), and then compares the acquired current sum of the used heap capacities with the threshold (S374).

If the sum of the used heap capacities is equal to or larger than the threshold (Yes in S374), the collection management program 140 sets the GC execution flag to the active state (S375), and finishes the GC execution opportunity determination processing in FIG. 6.

Conversely, if the sum of the used heap capacities is less than the threshold (No in S374), the collection management program 140 finishes the GC execution opportunity determination processing in FIG. 6.

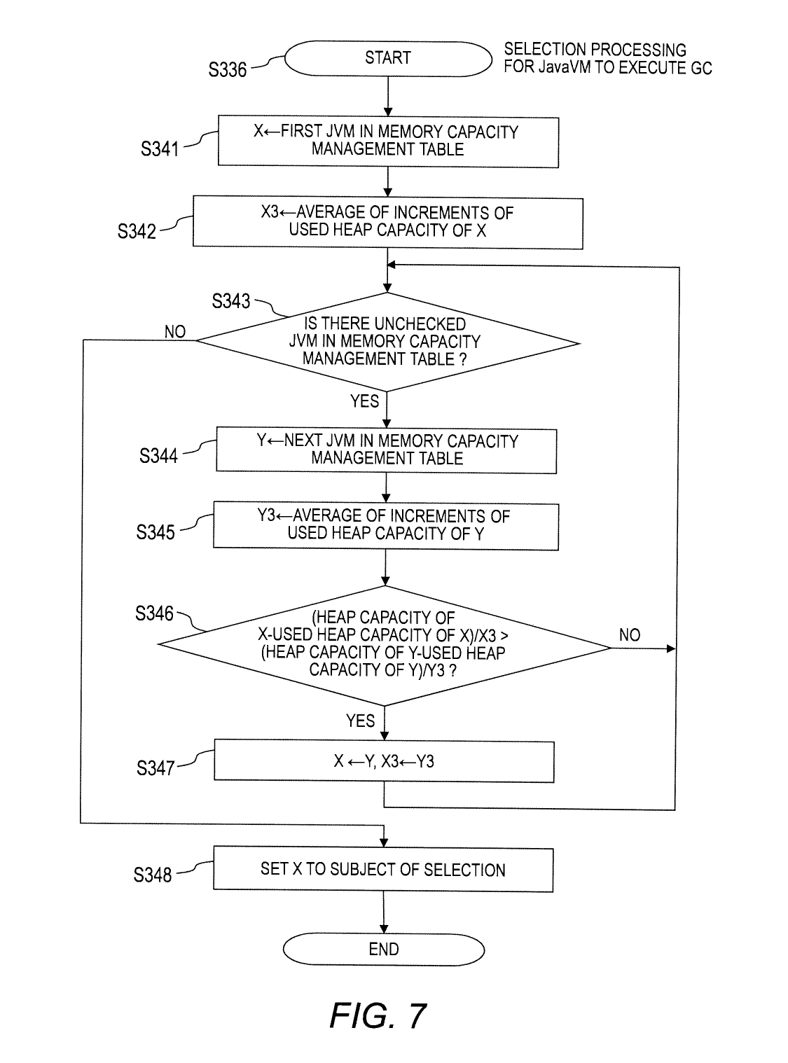

A description is now given of the processing S336 for selection of the JavaVM to execute the GC by the GC-execution-JavaVM selection module 145 illustrated in FIG. 7. This processing is processing of selecting, by the GC-execution-JavaVM selection module 145, the JavaVM 111 which has the nearest GC execution opportunity out of all the JavaVMs 111 registered to the memory capacity management table 142. A detailed description is now given of the processing.

First, the GC-execution-JavaVM selection module 145 stores in a variable X the JavaVM identifier 221 of the JavaVM 111 in the first entry of the memory capacity management table 142 (S341).

Then, the GC-execution-JavaVM selection module 145 acquires an average of values contained in the increment of used heap capacity 224 corresponding to X as used heap capacity incremental average X3 (S342).

Then, the GC-execution-JavaVM selection module 145 determines whether or not there is an unchecked JVM in the memory capacity management table 142 (S343). If there is an unchecked JVM, the GC-execution-JavaVM selection module 145 proceeds to processing in S344 (Yes in S343), and, if there is no unchecked JVM, the GC-execution-JavaVM selection module 145 proceeds to processing in S348 (No in S343).

Then, the GC-execution-JavaVM selection module 145 stores in a variable Y the JavaVM identifier 221 of the JavaVM 111 in the next entry in the memory capacity management table 142 (S344).

Then, the GC-execution-JavaVM selection module 145 acquires an average of values contained in the increment of used heap capacity 224 corresponding to Y as used heap capacity incremental average Y3 (S345).

Then, the GC-execution-JavaVM selection module 145 compares the next GC execution opportunities of the JavaVMs 111 stored in the used heap capacity incremental averages X3 and Y3 (S346). The GC-execution-JavaVM selection module 145 calculates the following equations (1) and equation (2) in this determination.

(the heap capacity 222 of X−the used heap capacity 223 of X)/the used heap capacity incremental average X3 (1)

(the heap capacity 222 of Y−the used heap capacity 223 of Y)/the used heap capacity incremental average Y3 (2)

If the value of the equation (1) is larger than the value of the equation (2) (Yes in S346), the GC-execution-JavaVM selection module 145 proceeds to processing in S347. Specifically, the GC-execution-JavaVM selection module 145 updates the value of the variable X with Y, and updates the value of the variable X3 with Y3 (S347). If the value of the equation (1) is equal to or less than the value of the equation (2) (No in S346), the GC-execution-JavaVM selection module 145 returns to the processing in S343, and repeats the processing in S343 to S347 until there is no unprocessed element (entry) in the memory capacity management table 142.

Finally, the GC-execution-JavaVM selection module 145 designates the JavaVM 111 stored in the variable X as a subject of selection (S348), and finishes the processing.

As a result of the above-mentioned processing, the identifier 221 of the JavaVM 111 having the nearest next GC execution opportunity can be determined by successively comparing the next GC execution opportunities in the order starting from the first entry of the memory capacity management table 142.

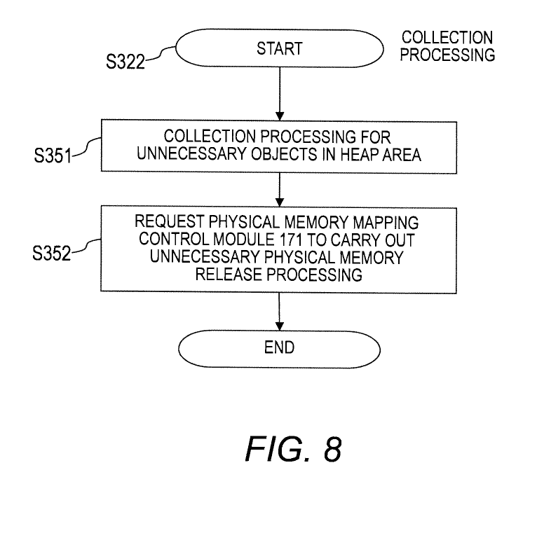

A detailed description is now given of the collection processing in S322 by the collection instruction notification reception module 132, referring to the flowchart in FIG. 8.

First, the collection instruction notification reception module 132 corresponding to the identifier 221 of the JavaVM 111 which is instructed to collect garbage objects in the heap area 112 by the collection management program 140 calls the GC processing module 120, thereby carrying out the GC processing for the heap area 112 (S351). As described above, the GC processing traverses reference relationships of objects in the heap area 112 by starting from the reference root 114, and determines as a garbage object an object which does not reach the last reference destination. The GC processing releases the heap area 112 occupied by the garbage objects.

Then, the collection instruction notification reception module 132 requests the physical memory mapping control module 171 of the hypervisor 170 to release a physical memory, which has become no longer necessary as the result of the GC processing, in order to release the memory 182 (physical memory) corresponding to the heap area 112 released in S351 (S352). The physical memory mapping control module 171 of the hypervisor 170, which has received the release request from the collection instruction notification reception module 132, can release the memory 182 corresponding to the heap area 112 released by the GC processing module 120, and can provide other virtual machines and the OS with the storage area.

As a result, in the computer 100 according to the first embodiment, the GC processing module 120 on the JavaVM 111 carries out the GC processing only if the JavaVM 111 receives the GC execution instruction from the virtual machine 110 executing the collection management program 140. The collection management program 140 issues the instruction to only one JavaVM 111 (or virtual machine 110) per GC execution opportunity. Hence, a plurality of JavaVMs 111 never carry out the GC processing simultaneously as in the conventional case. As a result, the timings of the GC execution are always different among the plurality of JavaVMs 111, which results in a stable operation with a smaller memory capacity than in the conventional case.

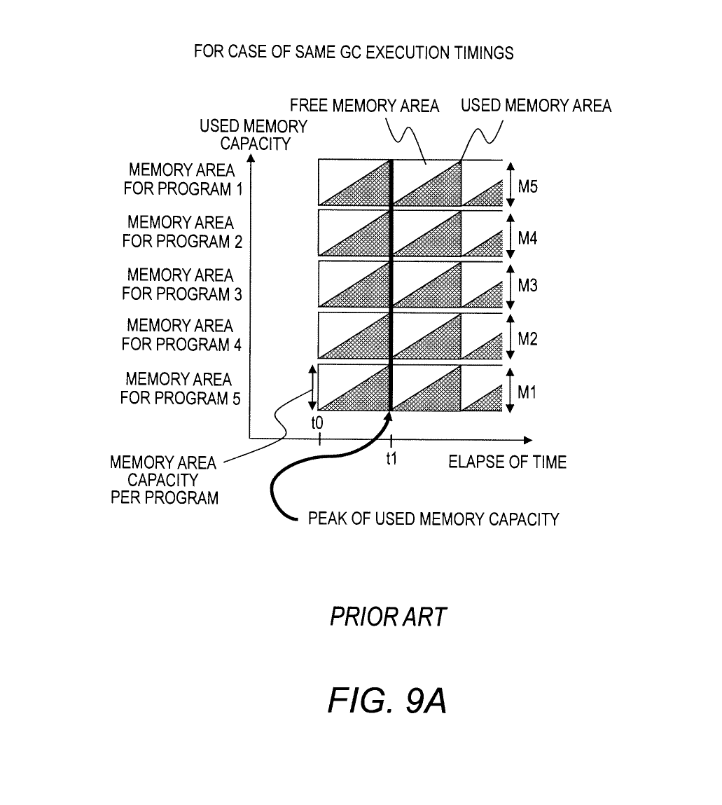

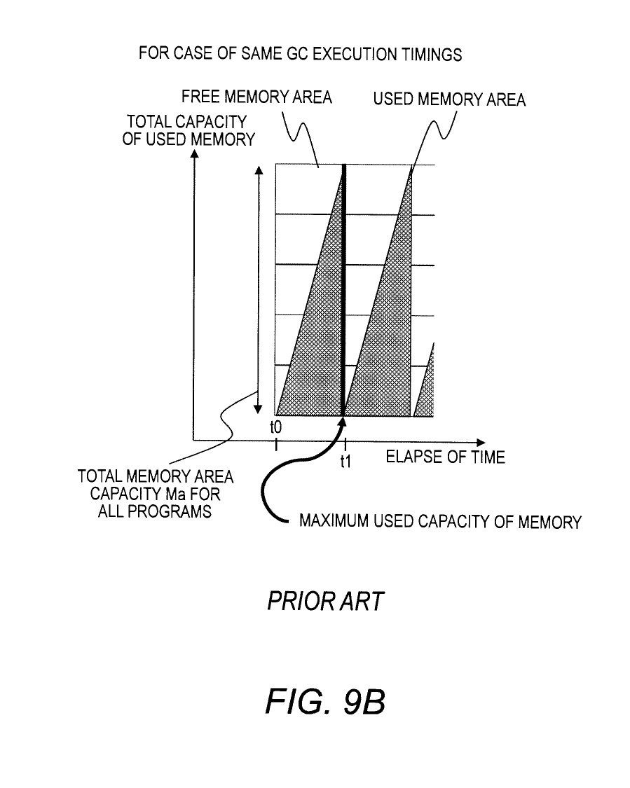

In other words, as mentioned in the conventional case, if the GC processing is carried out simultaneously in a plurality of the heap areas 112 the actually used capacity of the memory 182 coincides with the sum of the plurality of the heap areas 112 as illustrated in FIGS. 9A and 9B, and hence the storage area allocated to each of the heap areas 112 must be allocated in the memory 182. FIGS. 9A and 9B illustrate an example in which five programs (Java programs 113) respectively allocate heap areas and start running at a time t0, and simultaneously start the GC processing at a time t1. The example in FIGS. 9A and 9B illustrates an example in which five JavaVMs (programs 1 to 5 in the figures) run on the computer 100. The respective JavaVMs allocate capacities M1 to M5 as capacities of the heap areas 112 in the memory 182. The sum of the capacities M1 to M5 of the heap areas 112 of the respective JavaVMs is a total capacity Ma as illustrated in FIG. 9B

Therefore, in the conventional example, the respective Java program execution modules 115 gradually write objects in the respective heap areas 112 from the time t0, and hence the used heap capacities gradually increase. As a result, there are no free areas in the heap areas 112 at the time t1, and the used heap capacities become respectively equal to the heap capacities M1 to M5. There are no free areas in the respective heap areas 112 at this time t1, and the total capacity Ma, which is the sum of the heap capacities M1 to M5, is thus indispensable as the capacity of the physical memory area allocated on the memory 182.

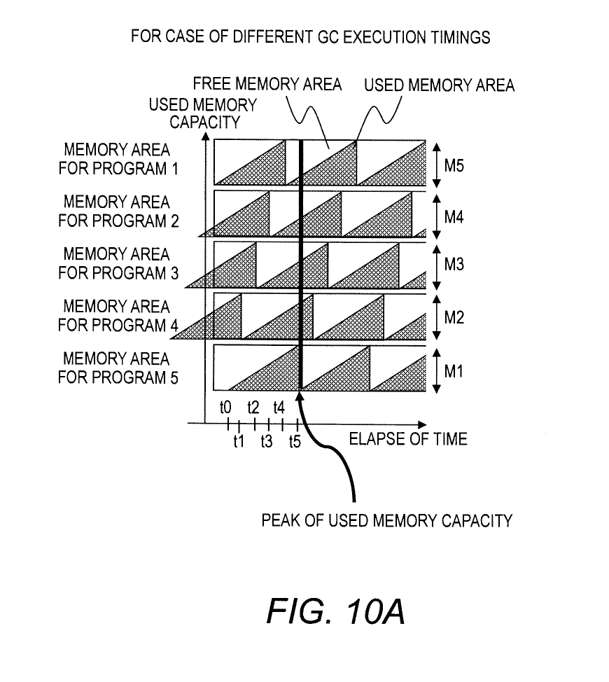

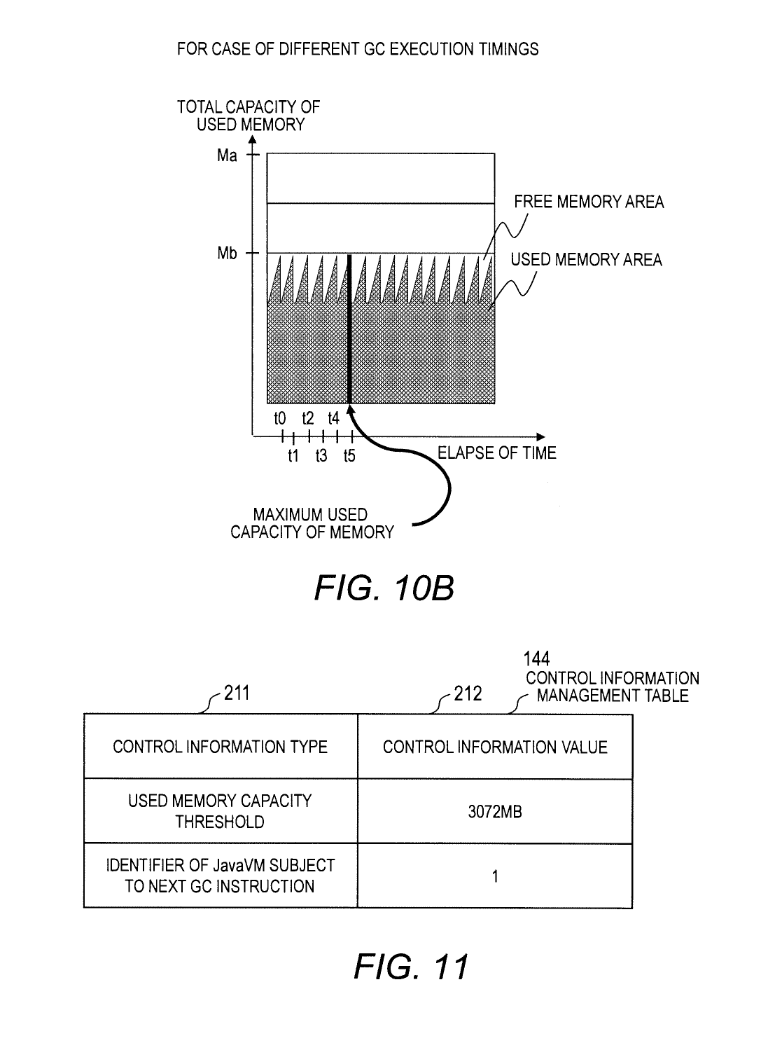

On the other hand, a relationship between the used heap capacities and the heap capacities holds as illustrated in FIGS. 10A and 10B according to the first embodiment. FIG. 10A illustrates, similarly to FIG. 9A, an example in which five JavaVMs (programs 1 to 5 in the figure) running on the computer 100, and the respective JavaVMs allocate capacities M1 to M5 in the memory 182 as the capacities of the heap areas 112. The sum of the capacities M1 to M5 of the heap areas 112 of the respective JavaVMs is the total capacity Ma as illustrated in FIG. 10B, which is the same as in the case illustrated in FIG. 9A.

According to the first embodiment, the GC processing for the program 5 is carried out at the time t0, then the GC processing for the program 4 is carried out at the time t1, the GC processing for the program 3 is carried out at the time t2, the GC processing for the program 2 is carried out at the time t3, the GC processing for the program 1 is carried out at the time t4, and the timings of the GC processing for the respective JavaVMs are thus different from each other. Each of the Java program execution modules 115 gradually writes objects in each of the heap areas 112, and the used heap capacity of each of the programs thus gradually increases after the GC processing. The used memory capacity then reaches a peak where the sum of the used heap capacities used by the respective programs becomes maximum at the time when the GC processing for each of the programs is carried out.

A relationship between the sum of the heap areas 112 to be used by the respective programs and the sum of the used heap capacities actually used holds as illustrated 10B. The sum of the used heap capacities reaches Mb, which is the maximum value, at the time point when the GC processing starts for each of the programs (JavaVMs). All the heap areas 112 do not become free areas after the GC processing is finished in each of the programs as illustrated in FIG. 9B of the conventional example, and the sum of the used heap capacities increase as the objects increase. The maximum value Mb of the sum of the used heap capacities actually used in the memory 182 is a smaller value than the total capacity Ma, which is the sum of the heap areas 112 of the respective programs, by the setting of the start times of the GC processing to different times for the respective programs.

Thus, according to this invention, the respective programs can be executed by allocating an area having a capacity of the maximum value Mb of the sum of the used heap capacities in FIG. 10B, as the area for the heap areas 112 allocated in the memory 182 of the computer 100. In other words, the physical mapping control module 171 of the hypervisor 170 allocates the total capacity Ma, which is the sum of the heap areas 112 illustrated in FIG. 10B, as the memory capacity for the heap areas 112 of the respective virtual machines 110 executing the JavaVMs 111, in a virtual storage area, and allocates physical addresses corresponding to the maximum value Mb of the sum of the used heap capacities actually used, on the memory 182.

As described above, according to the first embodiment, the capacity of the memory 182 can be reduced compared with the conventional case, and a plurality of the JavaVMs 111 can be executed, which results in efficient use of the resources of the computer 100.

Moreover, according to the first embodiment, only one of the plurality of the JavaVMs 111 is instructed to start the GC processing, the timings of the start of the GC processing are different from one another among the JavaVMs 111, and the simultaneous stop of the computing of the plurality of the Java programs 113 is eliminated, thereby securing the stable responsiveness. Further, the usage ratio of heap is employed as the index for determining the start of the GC processing, and the GC processing can be carried out at a proper time.

### Second Embodiment

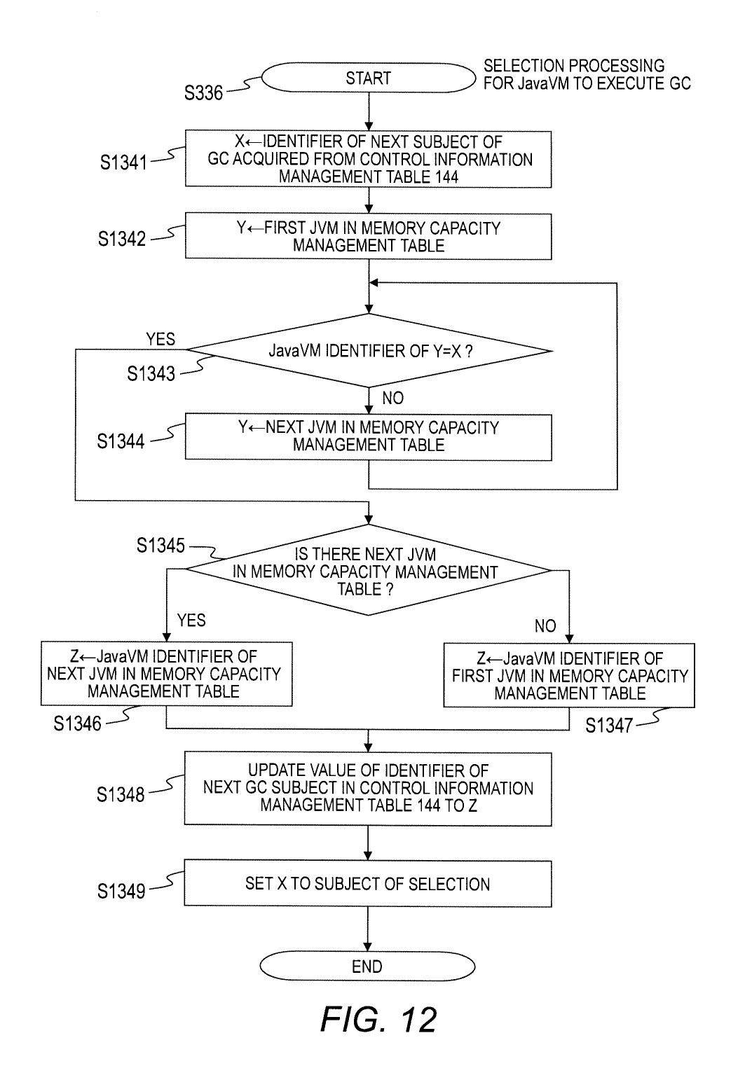

FIGS. 11 and 12 illustrate a second embodiment of this invention. Though the second embodiment carries out the same opportunity determination processing as the first embodiment, the subject of the notification of the GC execution instruction is each of the JavaVMs 111 sequentially selected, and the other configuration is the same as that of the first embodiment. As a method for sequentially selecting the JavaVM 111 according to the second embodiment, a description is given of an example employing the round robin, but the selection method is not limited to the round robin.

The processing of selecting “as a subject to which a GC execution instruction is notified, a JavaVM having the earliest next GC execution opportunity at the time point when the opportunity of the GC execution is reached” illustrated in FIG. 7 of the first embodiment is an effective method especially for a case in which most of the heap area 112 of the JavaVM having the earliest next GC execution opportunity is occupied by garbage objects.

On the other hand, according to the first embodiment, in the case where there is almost no unnecessary area in the heap area 112 of the subject JavaVM 111, even if the collection processing is carried out, the used heap capacity of this JavaVM 111 decreases little compared with that before the collection processing. As a result, this JavaVM 111 is repeatedly selected as the subject of the GC instruction thereafter.

The used heap capacities of the other JavaVMs 111 gradually reach the peaks during this period, and hence the peak times of this JavaVM 111 and the other JavaVMs 111 cannot be sufficiently separated from one another as a result. Therefore, the sum of the used heap capacities may exceed the threshold (used memory capacity threshold).

Prevention of the situation in which the same JavaVM is repeatedly selected as the subject of the collection processing if the JavaVMs 111 which are subject to the instruction are sequentially selected is one of features of the second embodiment.

The above-mentioned processing is realized by changing the data stored in the control information management table 144 according to the first embodiment as described later, and by changing the selection processing in Step S336 for the JavaVM 111 to execute the GC processing illustrated in FIG. 2 of the first embodiment.

The configuration of the computer 100 and the overview of the GC processing according to the second embodiment are respectively the same as those in FIGS. 1 and 2 according to the first embodiment, and descriptions thereof are therefore omitted.

A detailed description is now given of the difference between the second embodiment and the first embodiment.

FIG. 11 is a diagram illustrating data to be stored in the control information management table 144 according to the second embodiment. In the second embodiment, the information management table 144 contains the used memory capacity threshold and information on identifier for the next GC target. Data stored in the used memory capacity threshold is the same as that of the first embodiment. The identifier of the JavaVM which is the target of the GC instruction issued upon a next GC execution opportunity is stored in the identifier or the next GC target. The identifier for the next GC target is initialized to the value of the first JavaVM identifier in the memory capacity management table 142 by the management program 140 when the management program 140 starts.

A detailed description is now given of the processing in S336 for selecting the JavaVM to execute the GC according to the second embodiment, referring to the flowchart in FIG. 12.

The GC-execution-JavaVM selection module 145 selects the JavaVM 111 which is subject to the instruction based on the identifier for the next GC target stored in the control information management table 144, and updates the identifier for the next GC target so as to point to the JavaVM 111 in the next entry in the memory capacity management table 142.

The GC-execution-JavaVM selection module 145 acquires the identifier for the next GC target from the control information management table 144, and stores the identifier in a variable X (S1341).

The GC-execution-JavaVM selection module 145 then searches the memory capacity management table 142 for an item the JavaVM identifier 221 of which corresponds to the value of the variable X.

First, the GC-execution-JavaVM selection module 145 stores the first entry of the memory capacity management table 142 in a variable Y (S1342).

The GC-execution-JavaVM selection module 145 then compares the JavaVM identifiers 221 in X and Y with each other (S1343). If the identifiers are equal (Yes in S1343), the GC-execution-JavaVM selection module 145 proceeds to processing in S1345. If the identifiers are different (No in S1343), the GC-execution-JavaVM selection module 145 proceeds to processing in S1344. Specifically, the GC-execution-JavaVM selection module 145 stores an entry next to Y in the memory capacity management table 142 in the variable Y (S1344), and returns to the processing in S1343.

Next, the GC-execution-JavaVM selection module 145 determines whether or not the value of the variable Y is the last entry in the memory capacity management table 142 (S1345).

If the value is not the last entry (Yes in S1345), the GC-execution-JavaVM selection module 145 proceeds to processing in S1346, namely sets the JavaVM identifier 221 of the entry next to Y in the memory capacity management table 142 to a variable Z (S1346).

If the value is the last entry (No in S1345), the GC-execution-JavaVM selection module 145 proceeds to processing in S1347, namely sets the JavaVM identifier 221 of the first entry in the memory capacity management table 142 to the variable Z (S1347).

Next, the GC-execution-JavaVM selection module 145 updates the identifier for the next GC target in the control information management table 144 with the value of the variable Z (S1348), and designates the JavaVM 111 stored in the variable X as the subject of selection (S1349).

As a result, even if the JavaVM 111 the heap area 112 of which is mostly occupied by non-garbage objects is selected as the instruction subject of the GC, the computer 100 according to the second embodiment selects the JavaVM 111 sequentially (in the order of the entries in the memory capacity management table 142) to execute the GC processing by mean of the round robin. Therefore, the JavaVMs 111 other than this JavaVM 111 become the subject of the instruction in GC opportunities subsequent to the next GC opportunity, and the timings of executing the GC can be sufficiently separated between this JavaVM 111 and the other JavaVMs 111.

As a result, even if there is a JavaVM 111 most of the heap area 112 of which is occupied by non-garbage objects, it is possible to prevent the same JavaVM 111 from being selected as the subject of the GC processing, thereby to stably operate the plurality of Java programs 113 on a small memory capacity.

### Third Embodiment

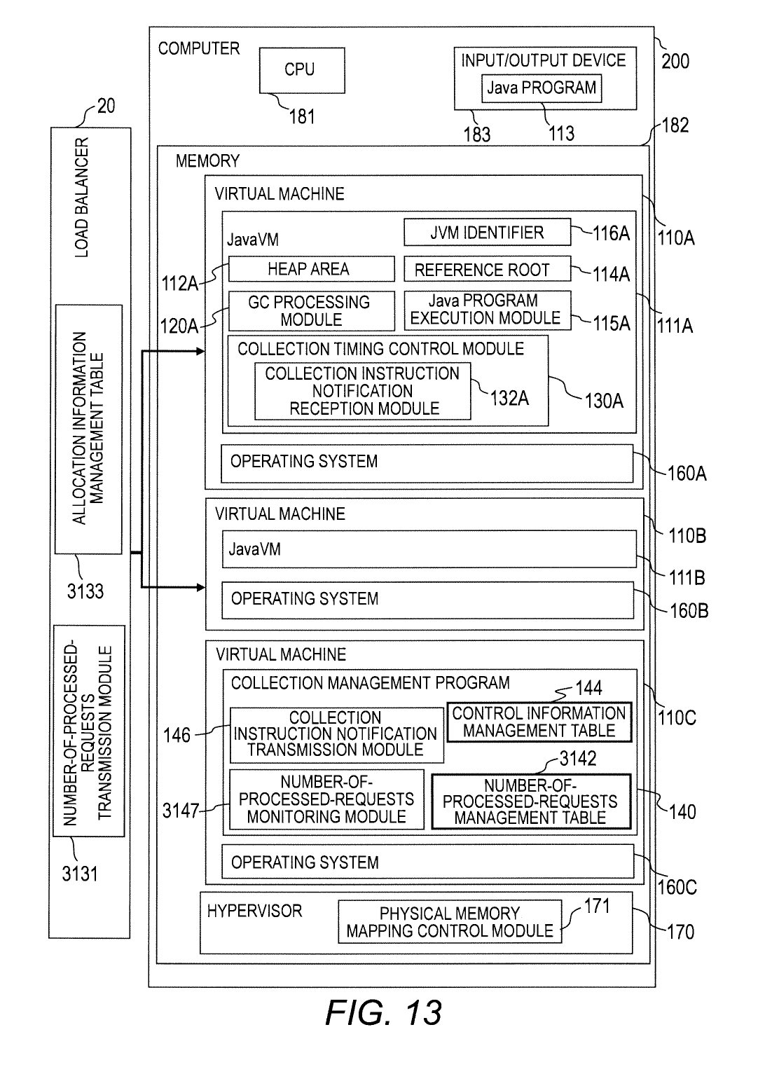

FIGS. 13 to 17 illustrate a third embodiment of this invention. In the third embodiment, a description is given of an example in which the determination of the GC execution opportunity described in the first embodiment is carried out based on the sum of the number of processed requests in a plurality of programs.

As in the first embodiment, if the used heap capacity is used for the determination of the GC execution opportunity, it is necessary for the opportunity determination to inquire the used heap capacities of the respective JavaVMs 111. Therefore, if there is no processing module for responding to the inquiry in the JavaVMs 111, this control is not available. Moreover, in the case where the collection management program 140 frequently makes the inquiry to the JavaVMs 111, the processing performance of the JavaVMs 111 may decrease.

In contrast, the number of processed requests to the JavaVMs 111 can be acquired by making the inquiry to a load balancer in a configuration employing a load balancer in FIG. 13. Moreover, processing is carried out in response to a request from a client in a general server application, and hence it is considered that the used heap capacity of the server is proportional to the number of processed requests.

According to this embodiment, the control is provided without the inquiry to the JavaVMs by using the number of processed requests in place of the used heap capacity for the opportunity determination.

FIG. 13 is a block diagram illustrating a configuration of a computer system centered around a computer 200 according to the third embodiment. The computer 200 is coupled to a load balancer 20 in the computer system according to the third embodiment. The load balancer 20 is a device which is coupled to client computers, which are not shown, via networks or the like and receives requests from client computers, thereby to distribute the received requests to the JavaVM 111A and 111B on the computer 200.

Moreover, the load balancer 20 also includes a distribution information management table 3133 and a number-of-processed-requests transmission module 3131. The distribution information management table 3133 is a table for storing the total number of requests which is the sum of requests which are distributed from the client computers to the respective JavaVMs 111 by the load balancer 20. The load balancer 20 updates values in the distribution information management table 3133 each time the requests from the client computers are distributed to the respective JavaVMs 111. The number-of-processed-requests transmission module 3133 is a processing module for transmitting information in the distribution information management table 3133.

The computer 200 according to the third embodiment is different from the computer 200 according to the first embodiment in the following points. First, in the third embodiment, the collection timing control module 130 in the JavaVM 111 does not include the memory capacity transmission module 131. Next, the collection management program 140 includes a number-of-processed-requests management table 3142 and a number-of-processed-requests monitoring module 3147 in place of the memory capacity management table 142 and the memory capacity monitoring module 147, respectively. The computer 200 according to the third embodiment is the same as the computer 200 according to the first embodiment in points other than the above-mentioned points.

The JavaVM 111B includes the same components as those of the JavaVM 111A as in the first embodiment, which is not illustrated, and the components are discriminated by adding a suffix “A” or “B” to a name of each of the functional portions if necessity particularly arises.

A detailed description is now given of the difference between this embodiment and the first embodiment.

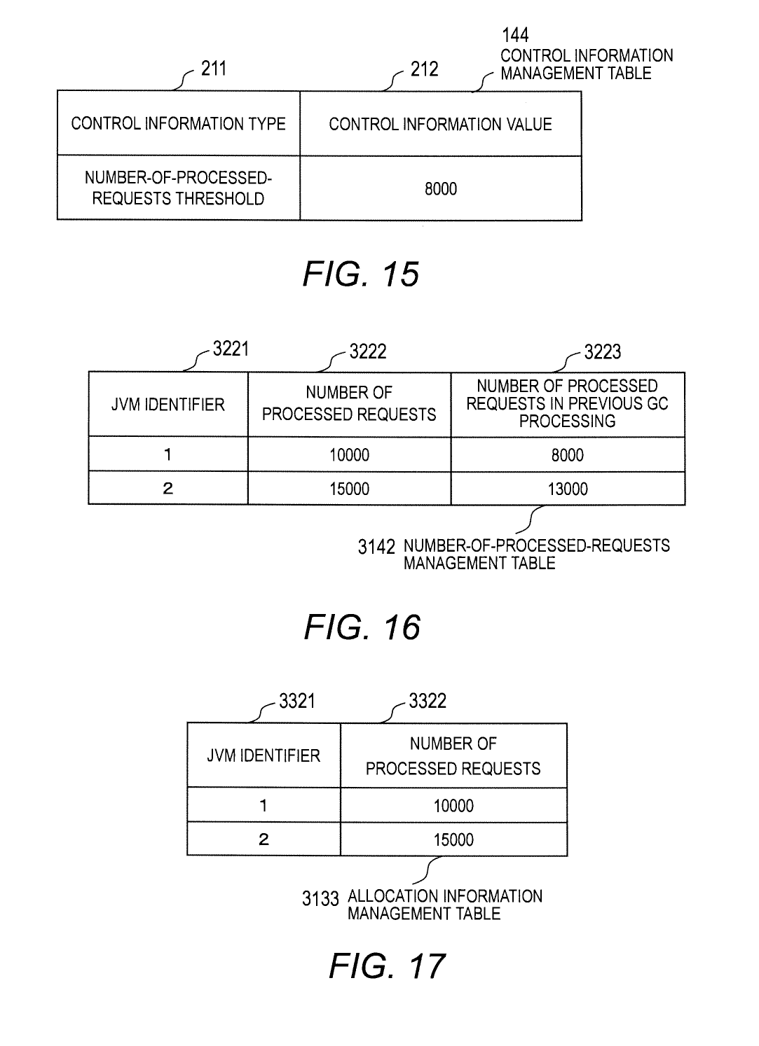

FIG. 15 is a table illustrating data to be stored in the control information management table 144 according to the third embodiment. According to the third embodiment, the control information management table 144 includes information on a number-of-processed-requests threshold as a threshold for determination of the GC execution in place of the data of the first embodiment. The number-of-processed-requests threshold stores a threshold to be compared with a sum of the number of requests on all the JavaVMs 111 to be processed by a next GC execution after the GC execution. The information on the number-of-processed-requests threshold is set in advance by the administrator or the like.

FIG. 16 is a table illustrating an example of a data format of the number-of-processed-requests management table 3142 according to this embodiment. The number-of-processed-requests management table 3142 includes a field of JavaVM identifier 3221, a field of number of processed requests 3222, and a field of number of processed requests in previous GC processing 3223.

The field of JavaVM identifier 3221 stores a JavaVM identifier 116 of a JavaVM 111 corresponding to each of data rows in this table. The field of number of processed requests 3222 stores a total number of requests processed by the corresponding JavaVM 111. The field of number of processed requests in previous GC processing 3223 stores a total number of requests processed by the corresponding JavaVM 111 by the most recent opportunity when the total number of processed requests of all the JavaVM 111 exceeds the threshold.

FIG. 17 is a table illustrating an example of a data format of the distribution information management table 3133 according to this embodiment. The distribution information management table 3133 includes a field of JavaVM identifier 3321, and a field of number of processed requests 3322. The field of JavaVM identifier 3321 stores a JavaVM identifier 116 of a JavaVM 111 corresponding to each of data rows in this table. The field of number of processed requests 3322 stores a total number of requests processed by the corresponding JavaVM 111.

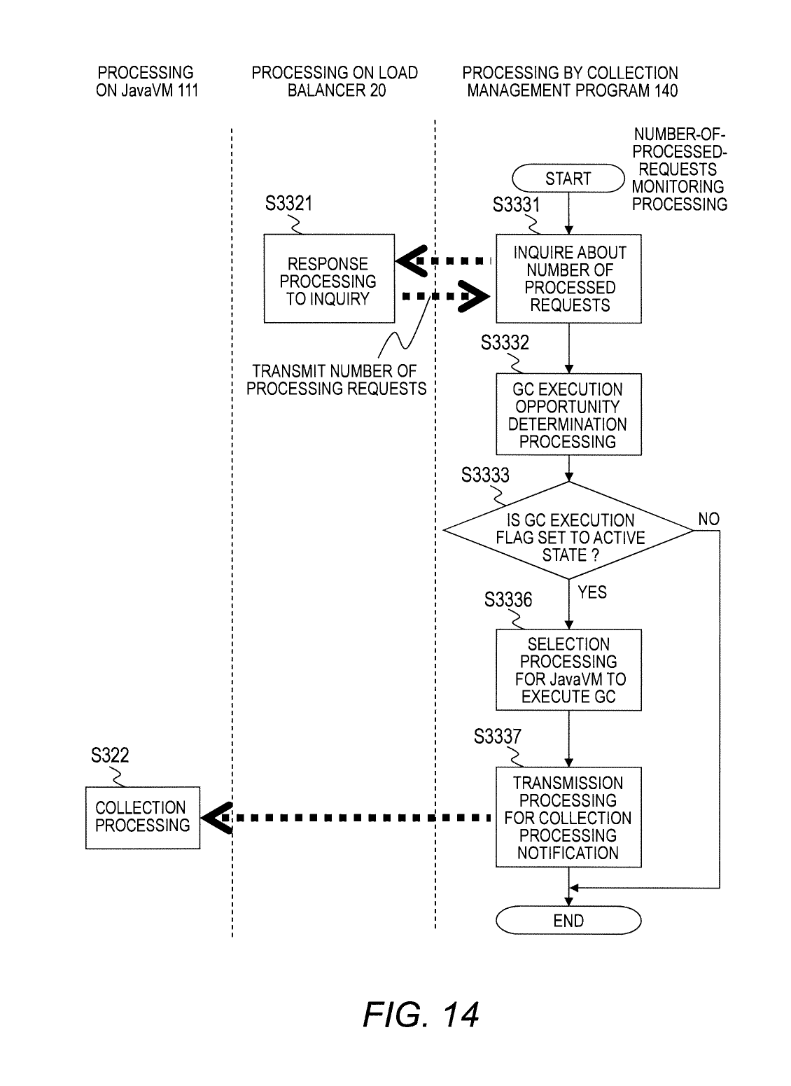

FIG. 14 is a diagram illustrating an overview of the GC control processing according to the third embodiment. The collection management program 140 periodically carries out the processing (at a predetermined cycle, for example) of FIG. 14 as in the first embodiment.

First, the collection management program 140 uses the number-of-processed-requests monitoring module 3147 to make an inquiry to the number-of-processed-requests transmission module 3131 in the load balancer 20 (S3331), and the number-of-processed-requests transmission module 3131 responds with the number of processed requests 3322 corresponding to the JavaVM identifier 3321 stored in the distribution information management table 3133 in response to the inquiry (S3321). The result of the response is stored by the number-of-processed requests monitoring module 3147 in the field of number of processed requests 3222 in the number-of-processed-requests management table 3142.

If the number-of-processed-requests monitoring module 3147 determines necessity of the GC execution based on the result of the response (S3332 and S3333), the collection management program 140 uses the GC-execution-JavaVM selection module 145 to select one of the JavaVMs 111 (S3336). The subsequent processing (S3337 and S332) is the same as that of the first embodiment.

The GC execution opportunity determination processing in S3332 calculates a sum of the numbers of requests processed by the respective JavaVMs 111 after the previous GC opportunity, and if the sum exceeds the threshold, it is determined that the GC execution opportunity is reached. The number of requests processed by each of the JavaVM 111 after the previous GC opportunity can be acquired by subtracting the value in the field of number of processed requests in previous GC processing 3223 from the value in the field of number of processed requests 3222 of the corresponding JavaVM in the number-of-processed-requests table 3142. Moreover, the threshold can be obtained from the used memory capacity threshold in the control information management table 144.

Moreover, a JavaVM 111 which has processed the maximum number of requests after the previous GC opportunity is selected in the selection processing in S3336. This processing can be executed by carrying out the same processing as in Step S336 in the first embodiment on the number-of-processed-requests management table 3142. The GC-execution-JavaVM selection module 145 copies the value of the field of number of processed requests 3222 of each of the JavaVMs to the field of number of processed requests in previous GC processing 3223 in the number-of-processed-request management table 3142 when the selection processing is finished.

The method of selecting the JavaVM to execute the GC is not limited to the above-mentioned method, and the round robin may be used as in the second embodiment.

As a result, on the computer 200 according to this embodiment, the control can be provided without making the inquiry to the JavaVMs 111 by determining the opportunity of the GC execution based on the information on the number of processed requests acquired from the load balancer 20. As a result, a load on the JavaVMs 111 can be reduced in addition to stably running the plurality of Java programs 113 on a smaller capacity of memory as in the first embodiment. The index to be used is not necessarily limited to the number of processed requests, and other index may be employed.

### Fourth Embodiment

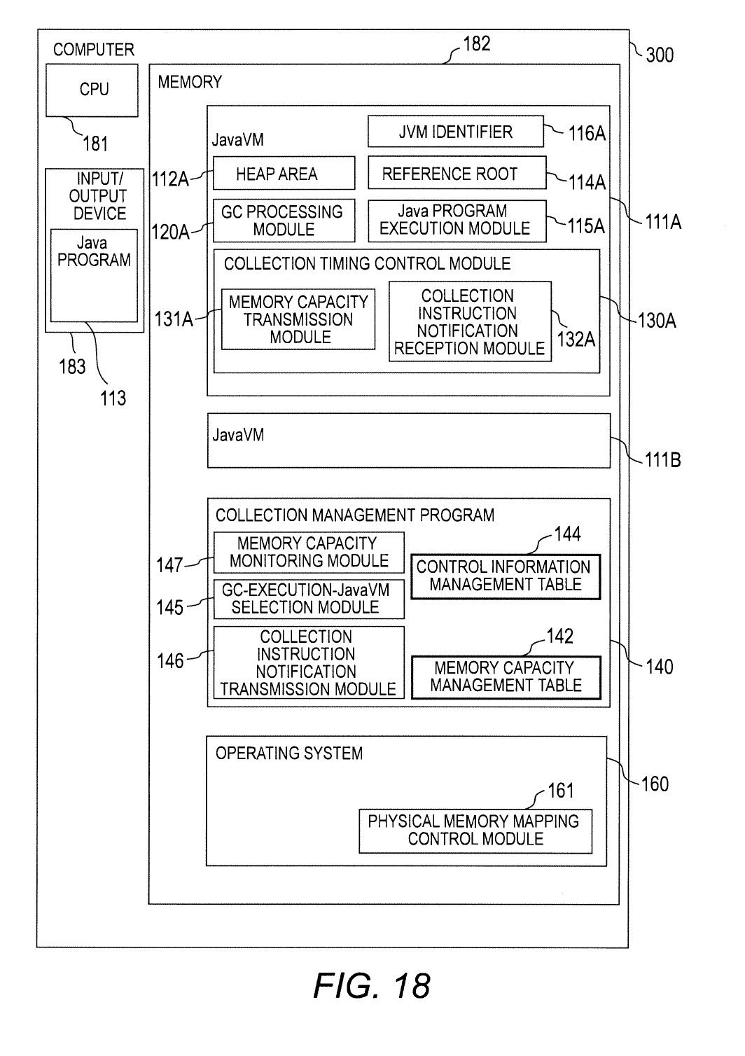

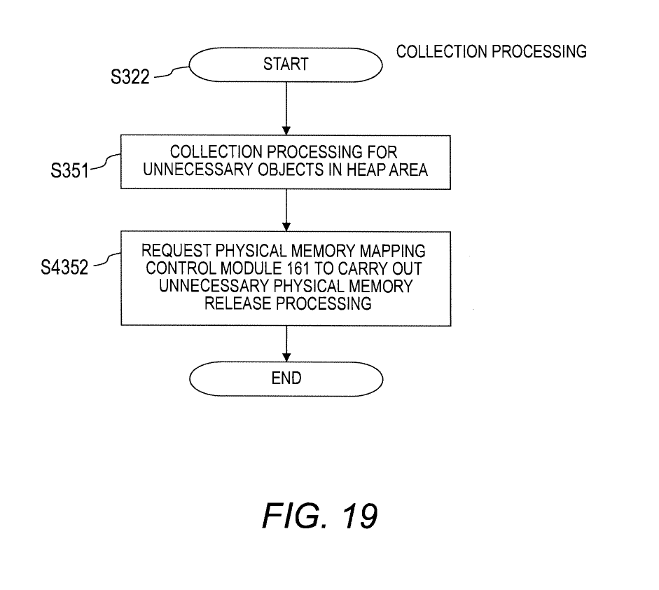

FIGS. 18 and 19 illustrate a fourth embodiment of this invention. As the fourth embodiment, a description is now given of an embodiment for a case where control is provided for a plurality of JavaVM processes operating on one operating system.

The fourth embodiment carries out the same control as in the first embodiment by using a physical memory mapping control module 161 of the operating system 160 in place of the physical memory mapping control module 171 of the hypervisor 170 according to the first embodiment.

FIG. 18 is a configuration block diagram of a computer 300 according to this embodiment. The JavaVMs 111 (111A and 111B), the collection management program 140, and the operating system 160 are stored in the memory 182. The JavaVMs 111 and the collection management program 140 operate as processes managed by the operating system 160.

The operating system 160 includes the physical memory mapping control module 161. The physical memory mapping control module 161 is a processing module for controlling the capacity of the memory 182 available for the processes managed by the operating system 160 as in the physical memory mapping control module 171 of the first embodiment, and each of the processes can request the physical memory mapping control module 161 to allocate a new memory or to release an already allocated memory. It should be noted that the physical memory mapping control module 161 can allocate a virtual storage space to each of the processes, and convert the physical storage space of the memory 182 to the virtual storage space. Moreover, the conversion of the physical storage space of the memory 182 to the virtual storage space may be carried out by hardware of the CPU 181.

The flow of the GC processing according to the fourth embodiment is the same as that of FIG. 2 of the first embodiment, and a description thereof is therefore omitted. A different point in processing between this embodiment and the first embodiment is only the contents of the collection processing in S322 illustrated in FIG. 8 of the first embodiment.

Referring to a flowchart of FIG. 19, a detailed description is now given of the collection processing in S322, which is the difference between this embodiment and the first embodiment.

First, the collection instruction notification reception module 132 calls the GC processing module 120, thereby carrying out the GC processing for the heap area 112 as in the first embodiment (S351). Then, the collection instruction notification reception module 132 makes a release request for a physical memory, which has become no longer necessary as a result of the GC processing, to the physical memory mapping control module 161 in the operating system 160 (S4352).

As a result, the computer 300 according to this embodiment can stably operate the plurality of JavaVMs 111 on a smaller capacity of memory by using the physical memory mapping control module 161 of the operating system 160 for the processing of releasing an unnecessary physical memory even in an environment in which there is no hypervisor.

The round robin may be used for the selection method for the JavaVM 111 for carrying out the GC processing as in the second embodiment. Moreover, similarly, the numbers of processed requests from the client computers may be used for the determination of the opportunity of the GC execution as in the third embodiment.

### Fifth Embodiment

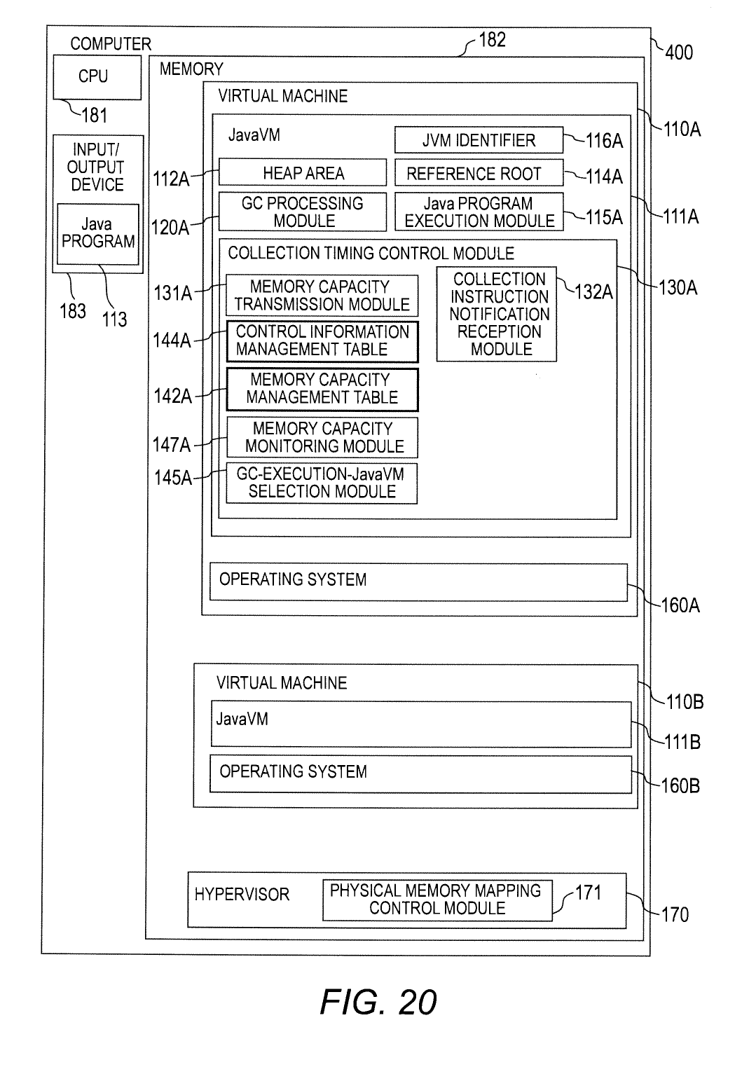

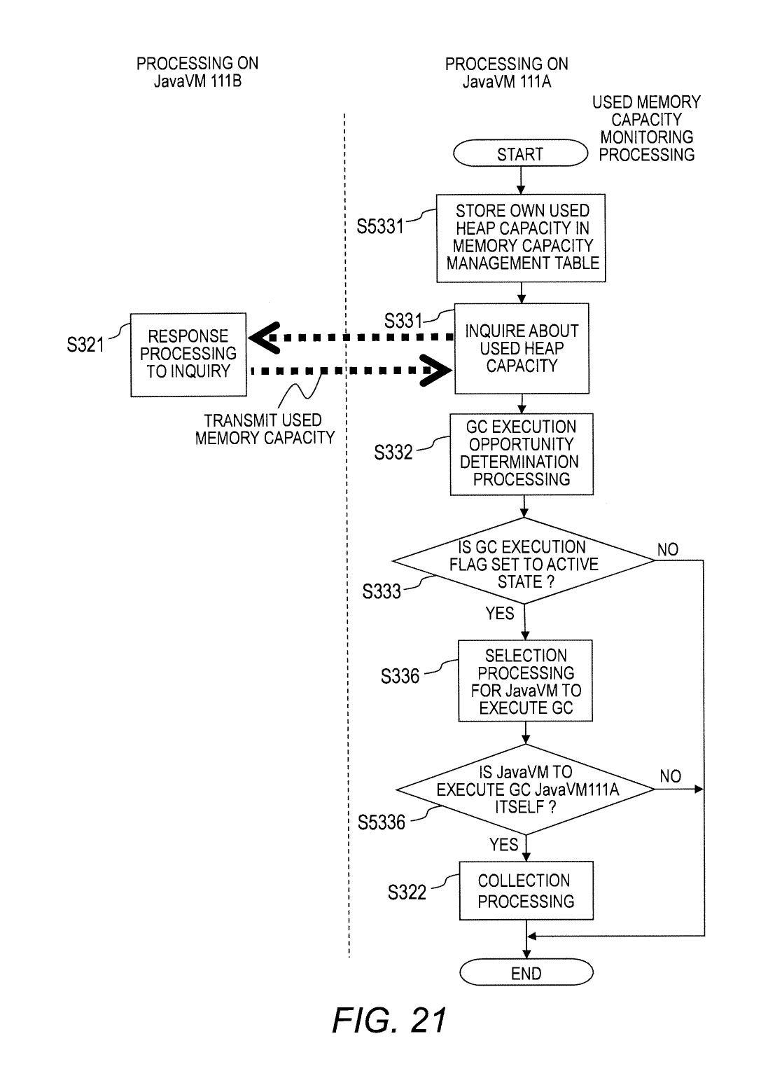

FIGS. 20 and 21 illustrate a fifth embodiment of this invention. An example of determining the opportunity for starting the GC by means of communication among JavaVMs without using a management program for the determination of the opportunity of the GC execution is described in the fifth embodiment.

If the collection management program 140 is used as in the first embodiment, and the management program 140 fails, the control of the GC processing is disabled, which results in a decrease in the usability. Therefore, according to the fifth embodiment, the above-mentioned problem can be solved by determining the opportunity only by means of the communication among the JavaVMs without using the management program 140.

FIG. 20 is a block diagram illustrating a configuration of a computer 400 according to this embodiment. A difference in components from the first embodiment is that there is not the virtual machine 110C (and the collection management program 140 contained in the virtual machine 110C) on the memory 182, and the control information management tables 144 (144A and 144B), the memory capacity management tables 142 (142A and 142B), the memory capacity monitoring modules 147 (147A and 147B), and the GC-execution-JavaVM selection modules 145 (145A and 145B) are instead contained in the collection timing control module 130 of the JavaVMs 111. Values stored in the control information management tables 144 and the memory capacity management tables 142 are the same as those of the first embodiment. Moreover, the memory capacity monitoring modules 147 and the GC-execution-JavaVM selection modules 145 carry out the same processing as in the first embodiment.

FIG. 21 is a diagram illustrating an overview of the GC processing according to this embodiment. The JavaVMs 111 call the processing of FIG. 21 periodically (at a predetermined cycle) while running.

Though a description is given only of the processing on the JavaVM 111A in FIG. 21 and the following description, the JavaVM 111B also carries out the same processing on the same opportunity.

First, the JavaVM 111A updates the own field of used heap capacity 223 in the memory capacity management table 142A to a value of the currently used rate of the heap area 112A, and adds an increment of the field of used heap capacity 223 to the field of increment of used heap capacity 224 (S331). The increment of the used heap capacity 223 is the same as that of the first embodiment, and is (the field of used heap capacity 223 after the update)-(the field of used heap capacity 223 before the update).

Then, the JavaVM 111A uses the memory capacity monitoring module 147A to make an inquiry to the memory capacity transmission module 131B in the JavaVM 111B (S331). The memory capacity transmission module 131B, which has received the inquiry, responds with the currently used heap capacity of the heap area 112B in response to the inquiry (S321). If the memory capacity monitoring module 147A determines that execution of the GC is necessary based on the result of the inquiry (S332 and S333), the JavaVM 111A uses the GC-execution-JavaVM selection module 145A to select one process out of all the JavaVMs 111 (S336). If the selected JavaVM 111 is not the JavaVM itself (namely, JavaVM 111A), the JavaVM 111A finishes the processing of FIG. 21. Conversely, the selected JavaVM 111 is the JavaVM itself, the JavaVM 111A uses the collection instruction notification reception module 132A to carry out the collection processing (S322).

It should be noted that the processing in S331, S321, S332, S333, S336, and S332 are the same as that of the first embodiment.

As a result of the above-mentioned processing, the computer 100 according to the fifth embodiment can determine the GC execution opportunity only based on the communication among all the JavaVMs 111, and, as a result, can stably operate the Java programs 113 using even a smaller physical memory capacity while avoiding the uncontrollable state of the heap area 112 due to the failed management program 140 according to the first embodiment.

The round robin may be used for the selection method for the JavaVM for carrying out the GC as in the second embodiment. Moreover, similarly, the numbers of processed requests may be used for the determination of the opportunity of the GC execution as in the third embodiment. Moreover, the physical memory control module 161 of the operating system 160 may be used in an environment without the hypervisor as in the fourth embodiment.

### Sixth Embodiment

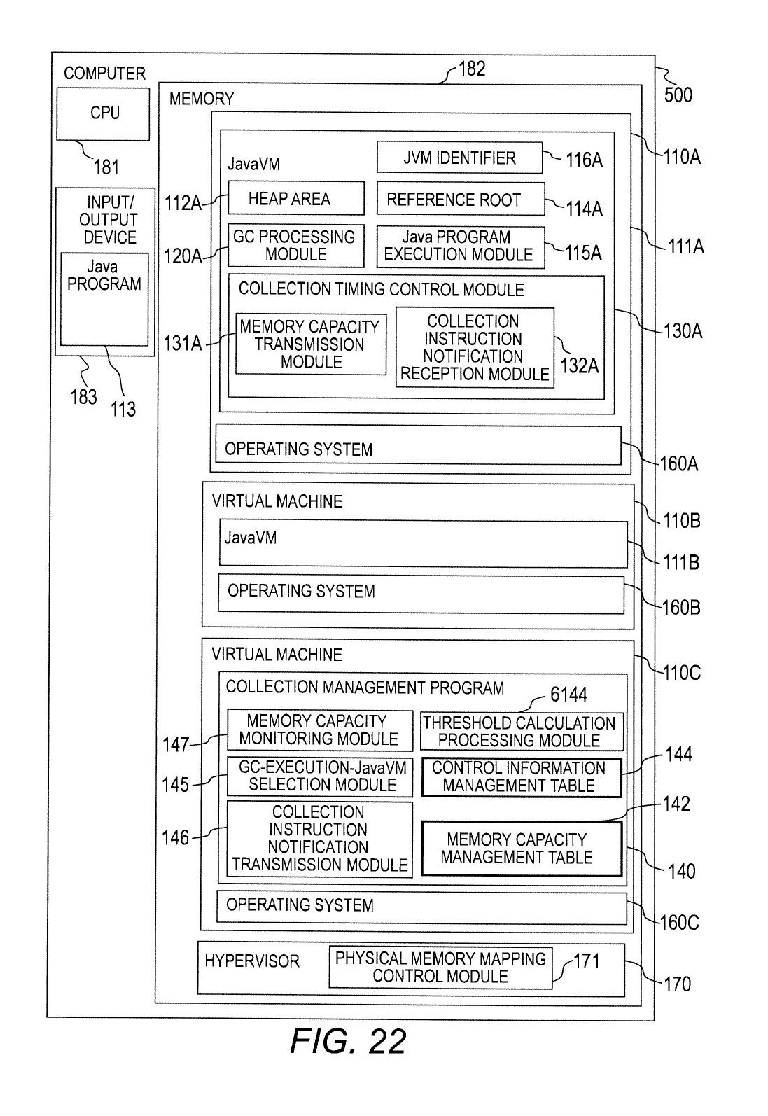

FIGS. 22 to 27 illustrate a sixth embodiment of this invention. According to the sixth embodiment, a description is given of a case where the used heap capacity is used as the index for determining the opportunity for the GC start, and as the threshold for the used heap capacity for determining the opportunity for the GC start, a proper threshold is not set by the administrator or the like as in the first embodiment, but is automatically calculated based on the usage ratio of heap (used rate of heap) after the GC processing of each of the JavaVMs 111 of the computer 500.

In general, a certain number of objects have not ended up with garbage objects, and remain as non-garbage objects in the heap area 112 even after the GC execution. For the non-garbage objects remaining in the heap area 112 even after the GC execution, the used heap capacity thereof is not reduced by shifting the GC execution timing. Therefore, if the sum of the used heap capacities, which is the sum of the used heap capacities of the respective JavaVMs 111, is used as the index for the GC start, it is necessary to subtract a capacity corresponding to the non-garbage objects remaining in the heap areas 112 in order to properly calculate a threshold for the sum of the used heap capacities. However, the capacity of the memory 182 occupied by the non-garbage objects remaining after the GC processing depends on a behavior of each of the Java programs 113, and hence it is difficult to calculate a proper threshold. If the threshold is larger than a proper value, an unnecessary memory is consumed, which results in a waste. Conversely, if the threshold is smaller than a proper value, there occurs a problem that an interval of the GC execution of each of the JavaVM 111 becomes short, which results in a decrease in processing performance of the Java program 113.

The sixth embodiment solves the above-mentioned problem by acquiring a capacity of the non-garbage objects remaining in the heap area 112 as remaining capacity information when the Java program 113 actually operates, and calculating the threshold for determining the opportunity for the GC start based on the remaining capacity information.

According to the sixth embodiment, a processing module for calculating the threshold is used in addition to the components of the first embodiment in order to realize the above-mentioned effect. Moreover, the processing carried out in the sixth embodiment includes processing of transmitting/receiving remaining capacity information on the non-garbage objects remaining in the heap area 112 after the execution of the collection processing for garbage objects, and processing of calculating the threshold based on the remaining capacity information in addition to the pieces of processing of the first embodiment. Moreover, the control information management table 144 and the memory capacity management table 142 according to the sixth embodiment include data required for calculating the threshold in addition to the data according to the first embodiment.

FIG. 22 is a block diagram illustrating a configuration of the computer system according to the sixth embodiment. The sixth embodiment has a feature that a threshold calculation processing module 6114 is contained in the collection management program 140 in addition to the components of the first embodiment. The threshold calculation processing module 6144 is a processing module for calculating the threshold as described later based on values stored in the control information management table 144 and the memory capacity management table 142. The other configuration is the same as that of the first embodiment.

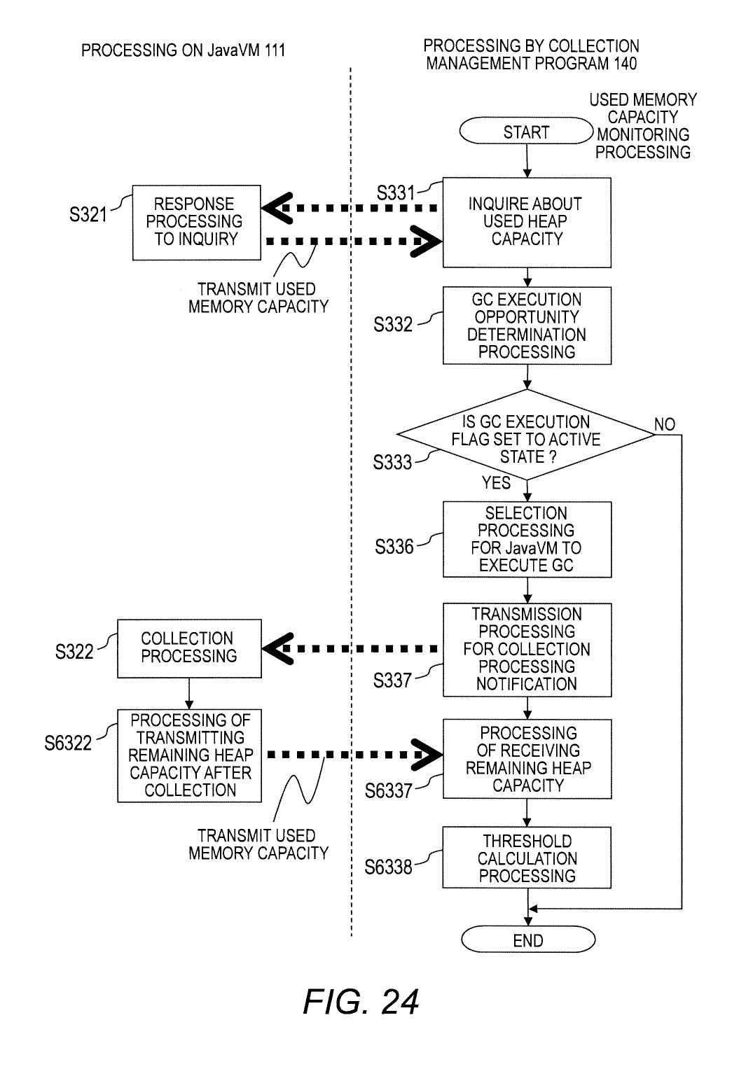

FIG. 24 is a diagram illustrating an overview of the GC control processing according to the sixth embodiment. This GC control processing has a feature that the GC control processing includes, in addition to the processing of FIG. 2 of the first embodiment, processing of transmitting remaining heap capacity after collection in S6322 for detecting the remaining capacity information on the non-garbage objects, and transmitting the information to the management program 140 after the collection processing in S322 in the JavaVM 111, and processing of receiving remaining heap capacity in S6337 for receiving the remaining capacity information from the JavaVM 111, and threshold calculation processing in S6338 for calculating a next threshold from the received remaining capacity information after the transmission processing for collection processing notification in S337 in the collection management program 140.

S331 to S337, S321, and S322 of FIG. 24 are the same as the processing illustrated in FIG. 2 according to the first embodiment, and a redundant description thereof is therefore omitted. After the collection processing in S322 is carried out by the collection instruction notification reception module 132 in the JavaVM 111, the used capacity information (used heap capacity) on the heap area 112 after the GC processing is transmitted by the memory capacity transmission module 131 as the remaining capacity information on the non-garbage objects to the collection management program 140 (S6322).

In the collection management program 140, after the transmission processing for collection processing notification in S337 is carried out, the collection notification transmission module 146 receives the remaining capacity information from the JavaVM 111, and adds the received remaining capacity information to a list in a field of remaining capacity upon GC 6224 of the memory capacity management table 142 (S6337), and the threshold calculation processing module 6144 then carries out the calculation processing for the threshold (S6338).

A detailed description is now given of the difference between this embodiment and the first embodiment.

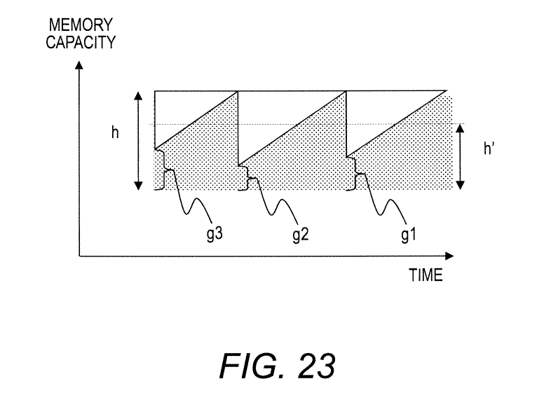

FIG. 23 illustrates an overview of the calculation method for the threshold carried out by the threshold calculation processing module 6144 of FIG. 22. In the figure, h denotes a heap area length, gi (i=1, 2, 3, . . . ) denotes a remaining capacity after the collection processing, and h′ denotes an average used capacity. In other words, h′ is represented as 0.5×(h+(average of g1, g2, g3, . . . )).

Information used for the calculation by the threshold calculation processing module 6144 includes the heap capacity (area length information in the figure (h in the figure)) of the heap area 112 of each of the JavaVMs 111, and the remaining capacities (g1, g2, g3, . . . in the figure) of the non-garbage objects after the GC execution by the JavaVM 111 for last N times. The average used capacity of the heap area 112 during the execution of the Java program 113 fluctuates between the remaining capacity of the non-garbage objects and the heap area length (heap capacity), and is an exactly the middle value between the remaining capacity of the non-garbage objects and the heap area length if the average is obtained by means of averaging with respect to time. The threshold calculation processing module 6144 calculates the average of the remaining capacities for the last N times, considers this average as an average remaining capacity, and calculates the threshold by obtaining an average of the average remaining capacity and the heap area length as the average used heap capacity.

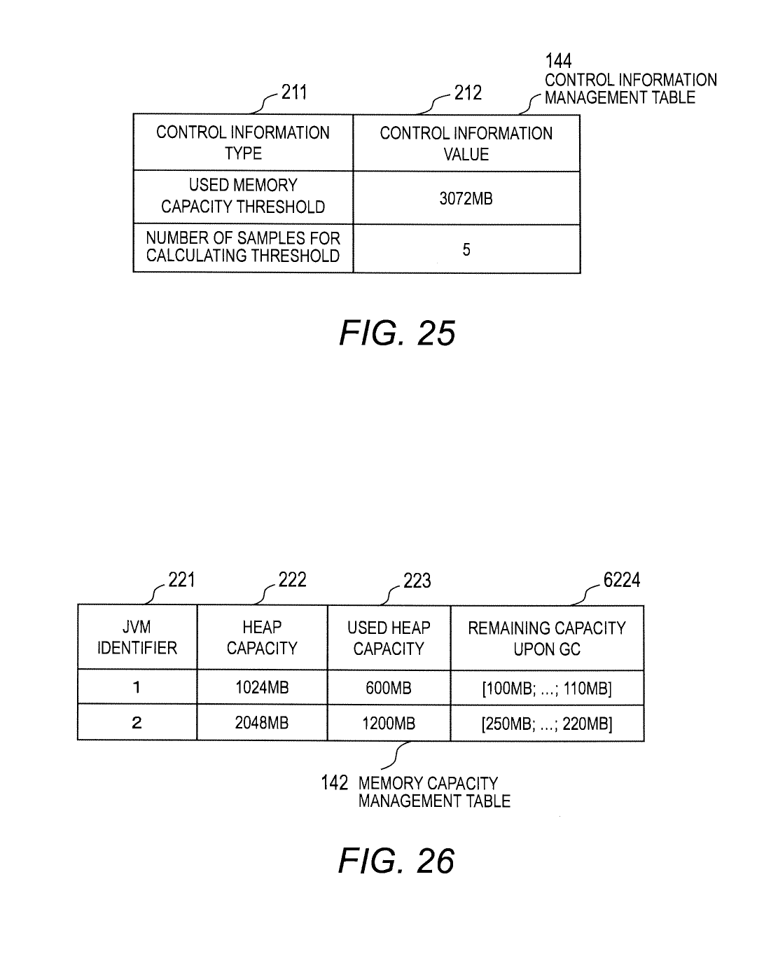

FIG. 25 is a diagram illustrating data to be stored in the control information management table 144 according to the sixth embodiment. The information management table 144 according to the sixth embodiment contains the used memory capacity threshold and information on a number of samples for calculating threshold. Data stored in the used memory capacity threshold is the same as that of the first embodiment. The information on the number of samples for calculating threshold stores the maximum number (N) of the pieces of the remaining capacity information on the non-garbage objects during the previous GCs used for calculating the threshold by the threshold calculation processing module 6144. The information on the number of samples for calculating threshold is set in advance by the administrator or the like.

FIG. 26 is a diagram illustrating data to be stored in the memory capacity management table 142 according to the sixth embodiment. The memory capacity management table 142 according to the sixth embodiment includes a field of remaining capacity upon GC 6224 in addition to the fields of the first embodiment. The field of remaining capacity upon GC 6224 stores a list maintaining the remaining heap capacities of the non-garbage objects upon the GC execution for at most last N times of the JavaVM 111 corresponding to the JVM identifier 221. It should be noted that N is a value stored in the number of samples for calculating threshold in the control information management table 144. The field of remaining capacity upon GC 6224 is initialized to a null list by the management program 140 when the management program 140 is activated. Moreover, if the number of elements of the list in the field of remaining capacity upon GC 6224 has reached the number of samples for calculating threshold in Step S6337, the oldest element is deleted and new data is added to the list.

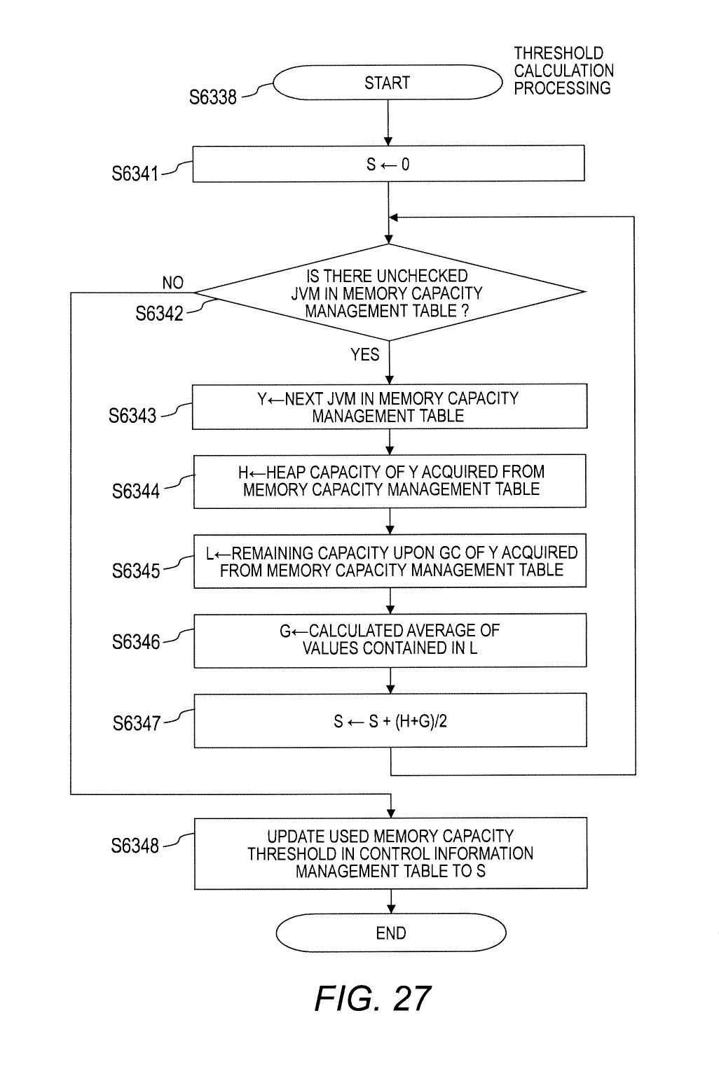

Referring to a flowchart of FIG. 27, a detailed description is now given of the processing in Step S6338, which is a particular feature of the sixth embodiment, out of the steps of FIG. 24. FIG. 27 is a flowchart illustrating the details of the processing carried out in S6338 of FIG. 24.

First, the threshold calculation processing module 6114 prepares a variable S for storing a new threshold, and initializes the value of the variable S to zero (S6341).

Then, the threshold calculation processing module 6144 determines whether or not there is an unchecked JVM in the memory capacity management table 142 (S6342), and if there is an unchecked JVM (Yes in S6342), the threshold calculation processing module 6144 proceeds to processing in S6343, and if there is not an unchecked JVM (No in S6342), the threshold calculation processing module 6144 proceeds to processing in S6348.

Then, the GC-execution-JavaVM selection module 145 stores the JavaVM identifier 221 of a next entry of the memory capacity management table 142 in a variable Y (S6343).

Then, the threshold calculation processing module 6144 sets the heap capacity 222 corresponding to Y to a variable H (S6344).

Then, the threshold calculation processing module 6144 sets (N of the remaining capacities) in the remaining capacity upon GC 6224 corresponding to Y to a variable L (S6345).

Then, the threshold calculation processing module 6144 acquires the average of N of the remaining capacities contained in the variable L as an average G of the remaining capacities upon GC (S6346).

Then, the threshold calculation processing module 6144 calculates the average used heap capacity based on the following equation (3), where the variable H denotes the heap area length of the corresponding JavaVM 111, and G denotes the average of the remaining capacities upon GC.

AVERAGE USED HEAP CAPACITY=(H+G)/2 (3)

Then, the threshold calculation processing module 6144 updates the value of the variable S based on the following equation (4) in order to acquire the sum of the average used heap capacities of the respective JavaVMs 111 (S6347).

Variable S=S+((H+G)/2) (4)

Finally, the threshold calculation processing module 6144 updates the used memory capacity threshold 223 in the control information management table 144 to the value of the variable S (S6348).

The calculation equation for the threshold is not limited to the equation (3).

As described above, in the computer 500 according to this embodiment, the GC processing can be realized based on the proper threshold (used memory capacity threshold) from which the remaining heap capacities of the non-garbage objects is subtracted by the threshold calculation processing module 6144 calculating the threshold information used for the control based on the usage ratio information on the heap area 112 after the GC processing of each of the heap areas 112.

Though the used memory capacity threshold is acquired from the average used heap capacities of the plurality of JavaVMs 111 in the above description, the average used heap capacity represented by the equation (3) may be used, and the used memory capacity threshold may be set to each of the JavaVMs 111

### Seventh Embodiment

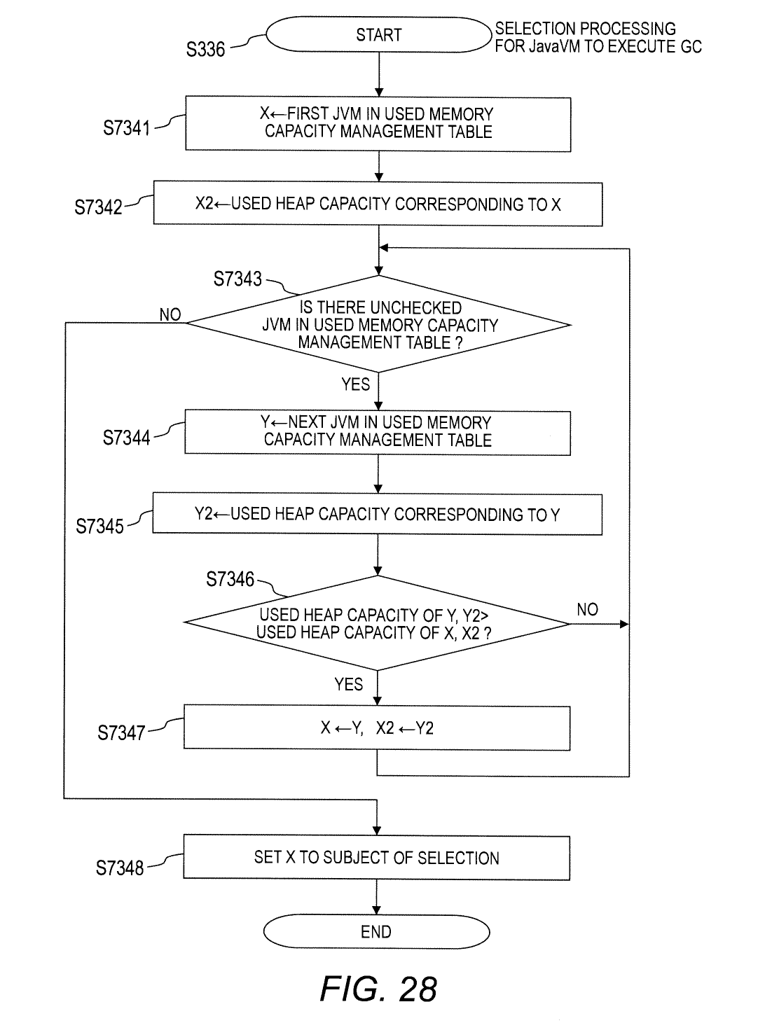

FIG. 28 then illustrates a seventh embodiment of this invention. Though the seventh embodiment carries out the same opportunity determination processing as that of the first embodiment, the used heap capacity 223 of each of the JavaVMs 111 is used as an index for determining the subject of the notification of the GC execution instruction, and the other configuration is the same as that of the first embodiment.

If the used heap capacity 223 of a subject JavaVM 111 is small, the decreased capacity of the sum of the used heap capacities after the collection processing is small, and the processing of selecting “a JavaVM having the earliest next GC execution opportunity as a subject to which a GC execution instruction is notified when the opportunity of the GC execution is reached” illustrated in FIG. 7 of the first embodiment requires frequent collection processing.

One of features of the seventh embodiment is effective collection processing by selecting a JavaVM 111 large in the used heap capacity 223 as the instruction subject, thereby maximizing the collected capacity of each collection opportunity.

This processing is realized by changing the selection processing in S336 of a JavaVM 111 to carry out the GC processing, which is illustrated in FIG. 2 of the first embodiment.

The configuration of the computer 100 and the overview of the GC processing according to the seventh embodiment are the same as respectively FIGS. 1 and 2 according to the first embodiment, and a description thereof is therefore omitted.

Referring to a flowchart of FIG. 28, a detailed description is now given of the selection processing in S336 for the JavaVM to execute the GC, which is the difference between the seventh embodiment and the first embodiment.

This processing is processing of selecting, by the GC-execution-JavaVM selection module 145, a JavaVM 111 highest in the used heap capacity out of all the JavaVMs 111 registered to the memory capacity management table 142.

First, the GC-execution-JavaVM selection module 145 stores the JavaVM identifier 221 of a JavaVM 111 in the first entry of the memory capacity management table 142 in a variable X (S7341). Then, the GC-execution-JavaVM selection module 145 stores the used heap capacity 223 corresponding to the JavaVM identifier 221 in a variable X2 (S7342).

Then, the GC-execution-JavaVM selection module 145 determines whether or not there is an unchecked JVM in the memory capacity management table 142 (S7343), and if there is an unchecked JVM (Yes in S7343), the GC-execution-JavaVM selection module 145 proceeds to the processing in S7344, and if there is not an unchecked JVM (No in S7343), the GC-execution-JavaVM selection module 145 proceeds to processing in S7347.

Then, the GC-execution-JavaVM selection module 145 stores the JavaVM identifier 221 of a next entry of the memory capacity management table 142 in a variable Y (S7344).

Then, the GC-execution-JavaVM selection module 145 stores the used heap capacity 223 corresponding to the JavaVM identifier 221 in a variable Y2 (S7345).

Then, the GC-execution-JavaVM selection module 145 compares the used heap capacities of the JavaVMs 111 stored in the used heap capacities X2 and Y2 with each other (S7346). It is determined whether or not the used heap capacity Y2 is larger than the used heap capacity X2 in this determination.

If the used heap capacity Y2 is larger than X2 (Yes in S7346), the GC-execution-JavaVM selection module 145 proceeds to processing in S7347, in other words, the GC-execution-JavaVM selection module 145 updates the value of the variable X to Y, and updates the value of variable X2 to Y2 (S7347). If Y2 is equal to or less than X2 (No in S7346), the GC-execution-JavaVM selection module 145 returns to the processing in S7343, and repeats the processing in S7343 to 7345 until there is no longer unprocessed element (entry) in the memory capacity management table 142.

Finally, the GC-execution-JavaVM selection module 145 specifies the JavaVM 111 stored in the variable X as the subject to selection (S7348), and finishes the processing.

The above-mentioned processing can determine the identifier 221 of the JavaVM 111 largest in the used heap capacity when the used heap capacity is successively compared starting from the first entry in the memory capacity management table 142.

As a result, in the computer 100 according to this embodiment, the collected capacity upon each collection opportunity can be maximized by the GC-execution-JavaVM selection module 145 selecting a JavaVM 111 large in the used heap capacity 223 as the subject to the instruction, which results in efficient collection processing.

The index for determining the subject of the notification of the GC execution instruction is not necessarily limited to the used heap capacity, and other index may be used. As an example of other index, a value obtained by subtracting the average remaining capacity from the used heap capacity is conceivable. It should be noted that the average remaining capacity is a remaining capacity of the non-garbage objects after the GC execution for last N times by the JavaVM 111 as in the sixth embodiment. Alternatively, as another example of the index, it is conceivable to use the used rate of heap of each of the JavaVM 111 as the index. It should be noted that the used rate of heap is the used heap capacity 223/the heap capacity 222.

Moreover, though the description is given of the GC processing to be applied to the memory 182 according to the first to seventh embodiments, it is known that the usage ratio of a storage device such as a disk by the log-structured file system (Rosenblum, Mendel and (justerhout, John K., The LFS Storage Manager, Proceedings of the 1990 Summer Usenix, pp. 315-324, for example), and the append-only database (Philip A. Bernstein, Nathan Goodman, Concurrency Control in Distributed Database Systems, ACM Computing Surveys (CSUR) Volume 13, Issue 2 (June 1981), pp. 185-221, for example) presents the same usage ratio characteristic as the usage ratio characteristic of the memory, and this invention may be applied.

As described above, this invention can be applied to a computer and a computer system for carrying out the GC processing, and can particularly be applied to a memory management method and a program on a computer for executing the JavaVMs.

What is claimed is:

1. A memory management method of, in a computer including a computing device and a memory, releasing an area which has become no longer necessary out of a plurality of memory areas respectively used by a plurality of programs stored in the memory and executed by the computing device, the memory management method comprising the steps of:
respectively acquiring, by the computing device, indices for determining a start of release of memory areas relating to the plurality of programs;
comparing, by the computing device, a sum of the indices and a predetermined threshold, and, when the sum exceeds the predetermined threshold, selecting a number of programs out of the plurality of programs, the number being smaller than a number of the plurality of programs;
collecting, by the computing device, an area which has become no longer necessary out of the memory areas used by the selected programs; and
releasing, by the computing device, the collected area out of the memory areas.

2. The memory management method according to claim 1, wherein each of the indices comprises a used memory capacity of each of the memory areas actually used by the plurality of programs.

3. The memory management method according to claim 1, wherein each of the indices comprises a number of requests received by each of the plurality of programs after a most recent opportunity for carrying out collection processing by the each of the plurality of programs itself.

4. The memory management method according to claim 2, wherein the step of comparing, by the computing device, a sum of the indices and a predetermined threshold, and, when the sum exceeds the predetermined threshold, selecting a number of programs out of the plurality of programs, the number being smaller than a number of the plurality of programs comprises:
predicting, by the computing device, a next opportunity when there is no free area in the each of the memory areas used by the plurality of programs; and
selecting a program having the earliest next opportunity when the sum exceeds the predetermined threshold.

5. The memory management method according to claim 2, wherein the step of comparing, by the computing device, a sum of the indices and a predetermined threshold, and, when the sum exceeds the predetermined threshold, selecting a number of programs out of the plurality of programs, the number being smaller than a number of the plurality of programs comprises selecting a program having a maximum used memory capacity of the plurality of memory areas used by the plurality of programs when the sum exceeds the predetermined threshold.

6. The memory management method according to claim 2, wherein the step of comparing, by the computing device, a sum of the indices and a predetermined threshold, and, when the sum exceeds the predetermined threshold, selecting a number of programs out of the plurality of programs, the number being smaller than a number of the plurality of programs comprises selecting, when the sum exceeds the predetermined threshold, in a predetermined order, the number of programs out of the plurality of programs, the number being smaller than the number of the plurality of programs.

7. The memory management method according to claim 1, wherein the step of comparing, by the computing device, a sum of the indices and a predetermined threshold, and, when the sum exceeds the predetermined threshold, selecting a number of programs out of the plurality of programs, the number being smaller than a number of the plurality of programs is executed by a management program different from the plurality of programs.

8. The memory management method according to claim 1, wherein the step of comparing, by the computing device, a sum of the indices and a predetermined threshold, and, when the sum exceeds the predetermined threshold, selecting a number of programs out of the plurality of programs, the number being smaller than a number of the plurality of programs is executed by the plurality of programs themselves.

9. The memory management method according to claim 1, wherein:
the plurality of programs are executed on a plurality of virtual computers generated by a virtualization module for virtualizing a physical computer resource on the computer; and
the step of releasing, by the computing device, the collected area comprises releasing, by the virtualization module, each of the memory areas.

10. The memory management method according to claim 1, wherein:
the plurality of programs are executed as a plurality of processes generated by an operating system for managing a physical computer resource of the computer; and
the step of releasing, by the computing device, the collected area out of the memory areas comprises releasing, by the operating system, each of the memory areas.

11. The memory management method according to claim 1, further comprising the step of acquiring, by the computing device, a capacity of the plurality of memory areas used by the plurality of programs, and a used capacity of the plurality of memory areas used by the plurality of programs after executing the step of releasing, the collected area, thereby calculating the predetermined threshold from the capacity and the used capacity.

12. A computer system, which includes a computing device and a memory, for executing a plurality of programs, and releasing an area which has become no longer necessary out of a plurality of memory areas respectively used by the plurality of programs, the computer system comprising:
a physical memory control module for allocating the memory to the plurality of programs;
an execution management module for setting the plurality of memory areas to be used for executing the plurality of programs on the memory for the plurality of programs;
a collection timing control module for acquiring indices for determining a start of releasing each of the plurality of memory areas used by the plurality of programs;
a collection processing module for detecting an unnecessary area out of the plurality of memory areas used by the plurality of programs, thereby collecting the unnecessary area; and
a collection management module for acquiring the indices respectively from collection timing control modules for the plurality of programs, and comparing a sum of the acquired indices and a predetermined threshold with each other, and instructing, when the sum exceeds the predetermined threshold, the collection processing module to collect the unnecessary area, wherein:
the collection management module compares the sum of the acquired indices and the predetermined threshold, and, when the sum exceeds the predetermined threshold, selects a number of programs, the number being smaller than a number of the plurality of programs out of the plurality of programs, and instructs the collection processing modules of the selected programs to collect the unnecessary area; and
the collection processing module detects the unnecessary area out of the plurality of memory areas, collects the unnecessary area, and then instructs the physical memory control module to release the collected unnecessary area.

13. A program for controlling a computer,
the computer including a memory for storing a plurality of programs, and a computing device for executing the programs stored in the memory; and
the program controlling the computing device to perform the procedures of:
acquiring indices for determining a start of release of a plurality of memory areas;
comparing a sum of the indices and a predetermined threshold, and, when the sum exceeds the predetermined threshold, selecting a number of programs out of the plurality of programs, the number being smaller than a number of the plurality of programs;
collecting an area which has become no longer necessary out of the memory areas used by the selected programs; and
releasing the collected area out of the memory areas.
